(19) United States
(12) Patent Application Publication
(10) Pub. No.: US 2019/0170360 A1
(43) Pub. Date: Jun. 6, 2019

(54) COOKING DEVICE

(71) Applicant: LG ELECTRONICS INC., Seoul (KR)

(72) Inventors: Yeonsik HA, Seoul (KR); Cheong Hwan YU, Seoul (KR); Jeongdong LEE, Seoul (KR)

(21) Appl. No.: 16/209,154

(22) Filed: Dec. 4, 2018

Related U.S. Application Data
(60) Provisional application No. 62/594,230, filed on Dec. 4, 2017.

(30) Foreign Application Priority Data
Dec. 3, 2018 (KR) 10-2018-0154009

(51) Int. Cl. F24C 7/08; G05G 1/015; G05G 1/10; H01H 19/02; H01H 19/14

(52) U.S. Cl. CPC F24C 7/082; G05G 1/015; H01H 2219/062; H01H 19/025; H01H 19/14; G05G 1/105

(57) ABSTRACT

The present disclosure relates to a cooking device which allows a user to quickly and easily set a cooking temperature and a cooking time. The cooking device includes a new type of control device configured to control a cooking process using the cooking device. The new type of control device, that is, a knob module includes a knob operated in a push-and-turn manner, a knob ring combined with the knob and operated in a click or holding manner, and a display unit integrally formed with the knob ring and capable of displaying a temperature, a heating power level, time, or other information set according to an operation of the knob or the knob ring. According to the present disclosure, an amount of heat energy supplied through the cooking device and a cooking time of the food may be quickly and easily adjusted.

### CROSS-REFERENCE TO RELATED APPLICATION

This application claims priority to and the benefit of U.S. Patent Application No. 62/594,230, filed on Dec. 4, 2017, and Korean Patent Application No. 10-2018-0154009, filed on Dec. 3, 2018, the disclosures of which are incorporated herein by reference in its entirety.

### BACKGROUND

### 1. Field of the Invention

The present disclosure relates to a cooking device which allows a user to set a cooking temperature and a cooking time quickly and easily.

### 2. Discussion of Related Art

Cooking devices are one of home appliances for cooking food and may be classified into various types of cooking device according to a heating source to be used, a type of cooking method, a type of fuel, or the like.

Cooking devices may be classified into an open-type and a sealed-type depending on a shape of a space where foods are placed.

Sealed-type cooking devices are types of the cooking device which shields a space where food is placed and heats the shielded space to cook the food. The sealed-type cooking devices include an oven, a microwave oven, and the like.

Open-type cooking devices are types of the cooking device which cooks food by heating a container containing food or food placed in an open space. The open-type cooking devices include a gas stove, an induction range, and the like.

In recent years, combination type cooking devices having both the sealed-type cooking device and the open-type cooking device and capable of cooking food in various ways are used. In the combination type cooking device, the open-type cooking device is mainly disposed on an upper portion thereof, and the sealed-type cooking device is mainly disposed on a lower portion thereof. The combination type cooking device may include a plurality of open-type cooking devices of different types and sealed-type cooking devices of different types. Thus, a user may cook food using the combination type cooking device at the same time in different ways.

The user needs to adjust an amount of heat energy supplied by a heating source provided in the cooking device in order to use the cooking device. The amount of the heat energy supplied by the heating source of the cooking device may be displayed as a cooking temperature and a heating power level depending on the type of the cooking device. That is, the user may adjust the amount of the heat energy supplied to the food or containers by adjusting the cooking temperature and the heating power level displayed on the cooking device. Further, the user may set a time at which the food is cooked, i.e., the cooking time in addition to the adjustment of the amount of the heat energy

An operation method for adjusting the amount of the heat energy and the cooking time for the cooking differs according to the type of the cooking device. Korean Patent Publication No. 10-2011-0079007 discloses a structure and an operation method of a combination cooking device according to the related art.

FIG. 1 illustrates a structure of a combination cooking device according to the related art.

Referring to FIG. 1, a combination cooking device 10 according to the related art includes a cooktop unit 21 configured to heat food or a container containing the food placed thereon to cook the food, an oven unit 30 configured to heat an inner space thereof in which the food or the container containing the food is placed to cook the food, a drawer unit 40 configured to store the food placed in an inner space thereof in a warm state or worm up the food, and a control unit 51 configured to control the cooktop unit 21, the oven unit 30, the drawer unit 40.

The cooktop unit 21 includes a plurality of cooktop heaters 22 which provide heat energy to heat the food or the container. The oven unit 30 includes a cooking chamber (not shown), which is the inner space of the oven unit 30 in which the food or the container containing the food is placed, and a door 32 configured to open and close the cooking chamber. The door 32 is provided with a handle 33 for gripping when the user opens or closes the door 32. Further, the drawer unit 40 includes a handle 41 for gripping when the user moves the drawer unit 40 forward or backward.

A control panel 51 is disposed on a front surface of the cooktop unit 21, i.e., above the door 32. The control panel 51 is formed in a hexahedral shape having a certain inner space. A knob-type input unit 52 is provided on a front surface of the control panel 51 for the user to input operational signals for operating the cooktop unit 21, the oven unit 30, and the drawer unit 40.

As shown in FIG. 1, conventionally, an amount of heat energy supplied by a heating source provided in the cooking device or a cooking time is adjusted mainly by rotating the knob-type input unit 52.

However, according to the related art, since the user has to adjust the amount of the heat energy or the cooking time depending on only scales marked on the knob-type input unit, the user may not accurately and precisely adjust the amount of the heat energy or the cooking time.

Further, according to the related art, it is difficult for the user to easily and accurately grasp the amount of the heat energy supplied by the cooking device and the remaining cooking time in the cooking process.

### SUMMARY OF THE INVENTION

The present disclosure is directed to providing a cooking device which enables a user to easily and quickly adjust a level of heat energy supplied by the cooking device and the cooking time of the food.

The present disclosure is also directed to providing a cooking device capable of easily and quickly recognizing a variety of information such as a level of heat energy supplied by a heating module, a remaining cooking time, an operation mode of the heating module, or an operation status of the heating module

The present disclosure is also directed to providing a cooking device having a control means for allowing the user to control the cooking process more conveniently and accurately and to promptly check the information required for cooking.

The present disclosure is also directed to providing a cooking device which does not require replacement of the control means even if the heating module is replaced, by providing a single type of control means capable of controlling different type of heating modules.

The present disclosure is also directed to providing a cooking device having a simple and unified design by providing a single type of control means that is arranged independent of the heating module and can control different type of heating modules.

Aspects of the present disclosure are not limited to the above-described aspects, and other aspects and advantages of the present disclosure will be understood by the following description and will be more definitely understood through the embodiments of the present disclosure. Also, it will be easily appreciated that the aspects and advantages of the present disclosure may be implemented by means shown in the claims and a combination thereof.

A cooking device according to the present disclosure includes a new type of a control device configured to control cooking processes using the cooking device. The new type of control device, i.e., a knob module, includes a knob which operates in a push-and-turn manner and a knob ring which is coupled to the knob and operates in a click or hold manner, and a display unit formed integrally with the knob ring and capable of displaying a temperature, a heating power level, a time, or other information set according to an operation of the knob or the knob ring.

A user may accurately and conveniently set an amount of heat energy supplied by various heating sources included in the cooking device, that is, a heating module, or an operation time of the heating module, that is, a cooking time, using the knob module provided in the cooking device according to the present disclosure.

For example, when the user intends to set a cooking temperature of the heating module provided in the cooking device using the knob module, the user first sets a default value by rotating the knob in a first direction or a second direction. Due to the rotational movement of the knob, the heating power level assigned according to a rotational position of each knob is set as the heating power level of the heating module.

Also, the user may minutely set a desired cooking time by operating the knob ring included in the knob module.

The knob ring according to the present disclosure has a structure of returning to its initial position after moving within a predetermined angle in the first or second direction. In the present disclosure, an operation of the knob ring is classified into a click operation or a holding operation according to a time for which a state in which the knob ring is moved in the first or second direction is maintained.

In the present disclosure, an operation, in which the knob ring returns to its initial position before a preset reference time (for example, 2 seconds) passes after the user moves the knob ring in any direction within the predetermined angle, is defined as the click operation of the knob ring. An operation, in which a state in which the knob ring is moved is maintained over the preset reference time (for example, 2 seconds) after the user moves the knob ring in any direction within the predetermined angle, is defined as the holding operation of the knob ring.

In this manner, in the present disclosure, it is possible to easily and precisely set the amount of the heat energy supplied by the heating module provided in the cooking device and the cooking time using the knob which operates in a push-and-turn manner and the knob ring which operates in a click or hold manner.

Values (for example, cooking temperature) set by the user using the knob module is immediately displayed on the display unit formed integrally with the knob ring whenever the user operates the knob or knob ring. In the process of cooking the food using the cooking device, various information such as the cooking temperature and the heating power level of the heating module set by the user, a remaining cooking time, whether the cooking is completed, and an operation mode are displayed on the display unit.

Thus, the user may more easily and accurately set the amount of the heat energy supplied by the heating module and the cooking time on the basis of information displayed on the display unit. Further, various information related to the cooking may be quickly and conveniently confirmed through the display unit even in the process of cooking.

Since the cooking device according to the present disclosure includes a plurality of different heating modules, various information regarding each heating module must be provided to the user during the cooking process. In the case of displaying such various information through a single display disposed at a position different from the control means of each heating module, the user has to check the display every time the control operation for each heating module is performed. This inconvenience increases as the size of the cooking device increases or as the type of the heating module increases.

Also, if information regarding a plurality of heating modules is displayed on a single display, the screen configuration of the display becomes complicated and it is difficult for the user to check desired information.

However, according to the present disclosure, each of the knob modules for controlling the respective heating modules includes a display unit, and information about corresponding heating modules is displayed on each of the display units simultaneously with the operation of the knob module. Therefore, the user can quickly and intuitively check information about each heating module whenever performing a control operation for each heating module.

Particularly, the display unit of the knob module according to the present disclosure is integrally formed with the knob ring. Information that is set or changed each time the user rotates the knob or moves the knob ring by touching the body (e.g., a finger) to the knob ring or the display unit is immediately displayed on the display unit. Thus, user's convenience is improved and information can be checked easily.

The display unit of the knob module according to the present disclosure is integrally formed with the knob ring in a protruding form on the knob ring surface. Due to such a structure, when the user operates the knob or the knob ring, the display unit is not blocked by the user's body (e.g., a hand), so that the visibility of the information displayed on the display unit is very high.

Also, according to the present disclosure, the heating operation for different types of heating modules can be controlled using the single type of knob module. According to the present disclosure, different knob modules corresponding to different types of heating modules are arranged on a single control panel. Thus, a simple and unified design for different types of heating modules is possible. As a result, the aesthetics of the product can be enhanced.

Also, according to the present disclosure, even if the type of the heating module included in the cooking device is changed, a single type of knob module can be applied. Further, the control panel in which the knob module is disposed in the cooking device is formed separately from the heating module. Thus, it is possible to produce various types of cooking devices having various combinations of heating modules by simply replacing the heating modules without replacing the knob modules. Accordingly, the manufacturing process can be simplified while lowering the designing difficulty and cost required for producing various types of cooking devices.

The cooking device according to the present disclosure has an advantage that the user can easily and quickly adjust the size of the heat energy supplied through the cooking device and the cooking time of the food.

Further, according to the present disclosure, the user may easily and quickly check various information such as a level of heat energy supplied by a heating module, a remaining cooking time, an operation mode of the heating module, or an operation status of the heating module.

Further, the cooking device according to the present disclosure has an advantage that the user can more conveniently and accurately control the cooking process and promptly check the information required for cooking.

Further, the cooking device according to the present disclosure includes a single type of control means capable of controlling different heating modules. Therefore, even if the heating module constituting the cooking appliance is replaced, it is not necessary to replace the control means.

Also, the cooking device according to the present disclosure has a simple and unified design by providing a single type of control means that is independent of the heating module and can control different types of heating modules.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 illustrates a structure of a combination cooking device according to the related art;

FIG. 2 is a perspective view of a cooking device according to one embodiment of the present disclosure;

FIG. 3 is an exploded view illustrating a knob module according to one embodiment of the present disclosure;

FIG. 4 is a perspective view of a heating power adjustment unit according to another embodiment of the present disclosure;

FIG. 5 is an exploded view of the heating power adjustment unit according to another embodiment of the present disclosure;

FIGS. 6 and 7 are cross-sectional views illustrating an operation of the heating power adjustment unit according to another embodiment of the present disclosure;

FIGS. 8 and 9 are cross-sectional views illustrating an operation of a knob ring according to another embodiment of the present disclosure;

FIG. 10 is a block diagram illustrating components of the cooking device according to one embodiment of the present disclosure;

FIG. 11 illustrates an initialized state of a first knob module included in the cooking device according to one embodiment of the present disclosure;

FIG. 12 illustrates a state in which a first knob of the first knob module is pressed according to one embodiment of the present disclosure;

FIG. 13 illustrates a state in which the first knob of the first knob module has rotated according to one embodiment of the present disclosure;

FIGS. 14 and 15 illustrate states in which a first knob ring of the first knob module has moved in a first direction according to one embodiment of the present disclosure;

FIG. 16 illustrates a state in which the first knob ring of the first knob module has moved in a second direction according to one embodiment of the present disclosure;

FIG. 17 illustrates a method of igniting flame at a second burner of a gas stove module using a second knob module according to one embodiment of the present disclosure;

FIG. 18 illustrates a method of adjusting a heating power level of the second burner using the second knob module according to one embodiment of the present disclosure;

FIG. 19 illustrates a method of setting a cooking time of the second burner using the second knob module according to one embodiment of the present disclosure;

FIG. 20 illustrates a method of adjusting a heating power level of a griddle module using a third knob module according to one embodiment of the present disclosure;

FIG. 21 is a view illustrating a preheating end notification operation of a griddle module according to one embodiment of the present disclosure;

FIG. 22 illustrates a method of setting a cooking time of the griddle module using the third knob module according to one embodiment of the present disclosure;

FIG. 23 is a flowchart illustrating a process of operations of the gas stove module according to one embodiment of the present disclosure;

FIG. 24 is a flowchart illustrating an operational process of the griddle module according to one embodiment of the present disclosure; and

FIG. 25 is a flowchart illustrating a process of operations of the griddle module according to another embodiment of the present disclosure.

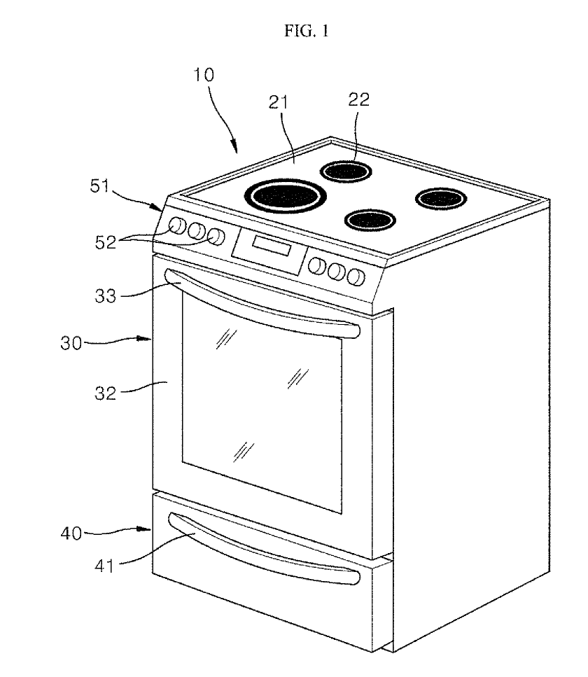

### DETAILED DESCRIPTION OF EXEMPLARY EMBODIMENTS

The above-described objects, features, and advantages will be described below in detail with reference to the attached drawings to allow one of ordinary skill in the art to execute the technical concept of the present disclosure easily. In the description of the embodiments of the present disclosure, a certainly detailed explanation of a well-known function or component of the related art will be omitted when it is deemed to unnecessarily obscure the essence of the present disclosure. Hereinafter, exemplary embodiments of the present disclosure will be described in detail with reference to the attached drawings. Throughout the drawings, like reference numerals refer to like or similar elements.

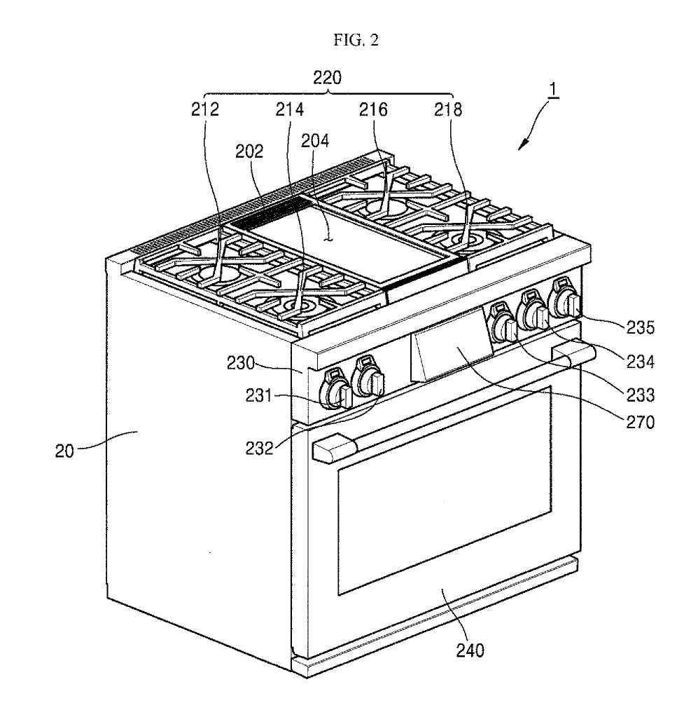

FIG. 2 is a perspective view of a cooking device according to one embodiment of the present disclosure.

Referring to FIG. 2, a cooking device 1 according to one embodiment of the present disclosure is a combination type cooking device and includes a plurality of heating modules. For example, as shown in the drawings, the cooking device 1 includes a griddle module 202 and a gas stove module 220 arranged above a main body 20. Also, an oven opened or closed by a door 240 disposed on a front surface of the main body 20 is disposed on a bottom of the main body 20.

For example, types of the heating modules and a position and an arrangement order of each of the heating modules included in the cooking device 1 shown in FIG. 2 are merely an example and may vary according to an embodiment.

Also, a control panel 230 configured to control a heating operation of each of the heating modules is disposed above the door 240 of the front surface of the main body 20.

The control panel 230 includes a plurality of knob modules 231, 232, 233, 234, and 235 configured to adjust at least one of a cooking temperature, a heating power level, and a cooking time of the griddle module 202 and the gas stove module 220. Hereinafter, as described above, each of the knob modules 231, 232, 233, 234, and 235 includes a knob, a knob ring, and a display unit.

Also, the control panel 230 includes a touch panel 270. The touch panel 270 recognizes a command input by a touch operation of a user or displays a variety of information related to cooking.

For example, the user may set a cooking temperature and/or a cooking time of the oven using the touch panel 270 or may control a heating operation of the oven by inputting a heating operation start command or a heating operation end command through a touch operation. Also, a variety of information related to cooking of food or an operation of the cooking device 1 such as a cooking temperature and/or a cooking time of the oven or an operation mode of the oven may be displayed on the touch panel 270.

A griddle 204 is mounted on the griddle module 202. The griddle 204 is a plate-shaped pan formed of a metal material having excellent heat conductivity, for example, aluminum and steel and having a predetermined thickness.

A heating device configured to supply heat energy to the griddle 204 is disposed below the griddle 204. In one embodiment of the present disclosure, the heating device disposed below the griddle 204 may be a gas burner which generates heat using gas but a type of the heating device may vary according to an embodiment.

Also, a temperature sensor configured to measure a current temperature of the griddle 204 heated by the heating device is disposed below the griddle 204. A temperature value measured by the temperature sensor is transferred to a control unit (not shown), and the control unit (not shown) controls a heating operation of the griddle module 202 according to the measured temperature value.

The user may set a cooking temperature of the griddle module 202 using a knob of the third knob module 233. When the user sets the cooking temperature of the griddle module 202 and the heating operation is started, sparks are generated by an ignition module and simultaneously a gas valve is opened and gas is supplied to ignite flames. After the flames are ignited, an amount of the supplied gas is adjusted by the gas valve according to the cooking temperature set by the user.

Also, the user may set a cooking time of the griddle module 202 using a knob ring of the third knob module 233. When the user sets the cooking time, measurement of the cooking time or countdown of the cooking time is started. When the cooking time set by the user is reached, it may be displayed on the display unit of the third knob module 233 that the countdown is finished. Also, when the cooking time set by the user is reached, a audio notifying of completion of the countdown may be output through a audio output unit included in the cooking device 1. As described above, the operation of notifying that the countdown is finished through the display unit or the audio output unit will be referred to as a countdown end notification operation.

In another embodiment, when the cooking time set by the user is reached, the control unit (not shown) may finish the heating operation of the griddle module 202 by blocking gas supply by closing the gas valve.

Also, when the user does not set the cooking time, the control unit may finish the heating operation of the griddle module 202 according to the heating operation end command of the user or may finish the heating operation of the griddle module 202 when a predetermined time limit is exceeded.

Referring back to FIG. 2, the gas stove module 220 supplies the heat energy to the food or the container with food therein using gas as a heating source. In FIG. 2, the gas stove module 220 includes a first burner 212, a second burner 214, a third burner 216, and a fourth burner 218. However, this is merely an example, and the number and positions of burners included in the gas stove module 220 may vary according to an embodiment.

The user may adjust a heating power level and/or a cooking time of each burner using a first knob module 231, a second knob module 232, a fourth knob module 234, and a fifth knob module 235 respectively corresponding to the first burner 212, the second burner 214, the third burner 216, and the fourth burner 218.

For example, the user, who intends to cook food using the first burner 212, rotates a knob of the first knob module 231 to a lite position. Accordingly, sparks are generated by an ignition module of the first burner 212 and simultaneously the gas valve is opened and gas is supplied so as to ignite flames.

When ignition is finished, the user adjusts a heating power level of the first burner 212 by rotating the knob of the first knob module 231. An amount of gas supplied through the gas valve is adjusted according to the heating power level set by the user using the knob of the first knob module 231.

Also, the user may set a continuous time of a heating operation performed by the first burner 212, that is, a cooking time, using a knob ring of the first knob module 231. When the user sets the cooking time using the knob ring of the first knob module 231, a countdown of the cooking time set by the user is started through a display unit of the first knob module 231.

When the cooking time set by the user is reached, it may be displayed on the display unit of the first knob module 231 that the countdown is finished. Also, when the cooking time set by the user is reached, a audio notifying of completion of the countdown may be output through the audio output unit included in the cooking device 1. As described above, the operation of notifying that the countdown is finished through the display unit or the audio output unit will be referred to as a countdown end notification operation.

In another embodiment, when the cooking time set by the user is reached, the control unit may finish the heating operation of the burner by blocking gas supply by closing the gas valve.

Also, when the user does not set the cooking time, the control unit may finish the heating operation of the burner according to the heating operation end command of the user or may finish the heating operation of the burner when a predetermined time limit is exceeded.

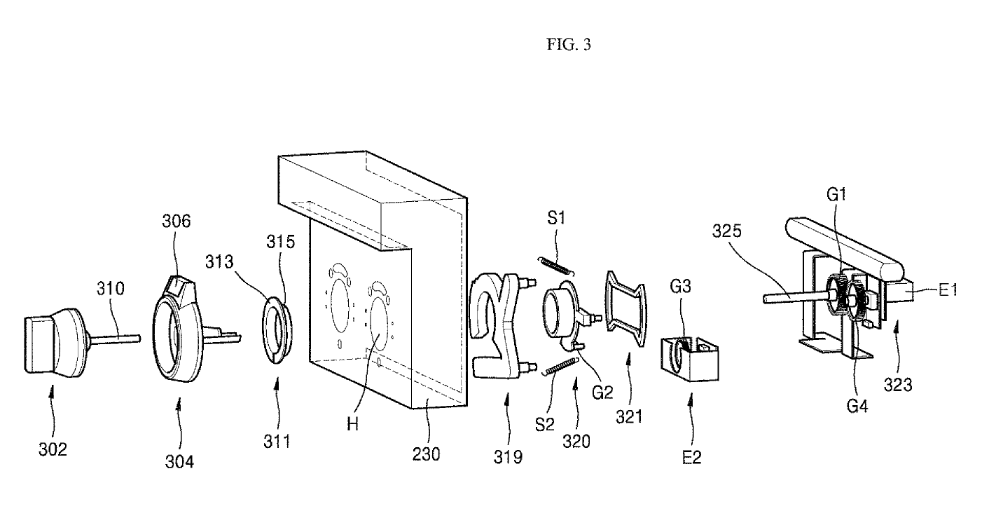

FIG. 3 is an exploded view illustrating a knob module according to one embodiment of the present disclosure. For reference, although FIG. 3 illustrates an exploded view of the first knob module 231, other knob modules may have the same structure as shown in FIG. 3.

A knob 302 includes a handle formed on top of a circular body and a knob shaft connected to an adjustment shaft 326 of a heating power adjustment unit 324. In the illustrated embodiment, although the handle has a bar-shaped protruding shape, the handle may have a variety of shapes.

The knob 302 may infinitely rotate in a first direction, for example, counterclockwise or a second direction, for example, clockwise. When the user rotates the knob 302, the knob 302 does not return to an initial position and remains in a position moved by the user. In one embodiment of the present disclosure, the knob 302 may be configured as a non-return type rotary switch.

When the heating module controlled by the knob module is a gas heating module or a gas stove, the heating power adjustment unit 324 is a valve assembly. Also, when the heating module controlled by the knob module is an induction heating module or an induction range, the heating power adjustment unit 324 is a heating power level adjustment device for adjusting a heating power level, for example, a variable resistor.

The knob 302 may be manufactured using a synthetic resin injection material or may be manufactured by processing a metal material. The knob 302 may have a variety of materials and shapes.

When the knob 302 rotates, a rotation direction and/or a rotation amount of the knob 302 is sensed by a knob shaft and a knob sensor E1 connected through the adjustment shaft 326. When the knob 302 rotates, a gear G1 combined with the adjustment shaft 326 and a gear G4 engaged with the gear G1 rotate. The knob sensor E1 senses a rotation direction and/or an amount of rotation of the knob 302 on the basis of an amount of rotation of the gear G4 and transmits the sensed rotation direction and/or amount of rotation to the control unit. The control unit may calculate a current position of the knob 302 on the basis of the rotation direction and/or the amount of rotation sensed by the knob sensor E1.

A knob ring 304 has a circular ring shape and is disposed on an outer circumferential surface of the knob 302. The knob ring 304 supports the knob 302 and finishes an exterior around the knob 302 to improve external quality of the knob module.

The knob ring 304 may rotate independently from the knob 302. The knob ring 304 can not infinitely rotate unlike the knob 302 and moves only by a predetermined angle in the first direction, for example, counterclockwise or the second direction, for example, clockwise.

When the knob ring 304 is rotated by the user, a rotation direction and/or an amount of rotation of the knob ring 304 is sensed by a knob ring sensor E2. When the knob ring 304 rotates, a gear G2 and a gear G3 engaged with the gear G2 provided at a support ring 320 connected to the knob ring 304 rotate. The knob ring sensor E2 senses the rotation direction and/or the amount of rotation of the knob ring 304 on the basis of a rotation direction and/or an amount of rotation of the gear G3 and transmits the sensed rotation direction and/or amount of rotation to the control unit. The control unit may check the rotation direction of the knob ring 304 and whether the knob ring 304 rotates on the basis of the rotation direction and/or the amount of rotation sensed by the knob ring sensor E2.

A display unit 123 is formed on an outer circumferential surface of the knob ring 304. The display unit 123 displays a value changed by movement of the knob 302 or the knob ring 304, for example, a cooking temperature or a cooking time. Also, the display unit 123 may display a variety of information related to an operational state or an operational mode of the heating module.

Letters or numbers displayed on the display unit 123 may be displayed in different colors according to a type of the heating module controlled by the knob module or a type of displayed letters or numbers. For example, a cooking temperature or a heating power level may be displayed in red and a cooking time may be displayed in white or blue.

The knob 302 and the knob ring 304 are exposed from a front surface of the control panel 230 while being combined with each other.

A bearing shell 311 includes a body part 315 having a cylindrical shape and a circular plate part 313 bent from the body part 315 and protruding in a radial direction. The body part 315 is inserted between an outer circumferential surface of the support ring 320 combined with the knob ring 304 and an inner circumferential surface of a fixing frame 322 and reduces friction between the support ring 320 and the fixing frame 322.

The circular plate part 313 is inserted between the control panel 230 and the knob ring 304 and reduces friction between the knob ring 304 and the control panel 230. Also, the circular plate part 313 allows the knob ring 304 to be spaced at a certain interval apart from the control panel 230 so as to reduce scratches or abrasions to the control panel 230 caused by friction generated between the knob ring 304 and the control panel 230 when the knob ring 304 rotates.

A support frame 319 is combined with a rear surface of the control panel 230 and supports the knob ring 304. Also, the support frame 319 surrounds the outer circumferential surface of the support ring 320 and supports the support ring 320 to allow the support ring 320 to rotate around a certain axis.

The support ring 320 is combined with a rear surface of the knob ring 304 and rotates while being integrated with the knob ring 304. Accordingly, an amount of rotation of the support ring 320 and the amount of rotation of the knob ring 304 are equal. Accordingly, when the amount of rotation of the support ring 320 is sensed, it is possible to sense the amount of rotation of the knob ring 304. In order to sense the amount of rotation of the support ring 320, the gear G2 may be included in the support ring 320.

The fixing frame 322 is fixed to the support frame 319 by a fastening component such as a screw and the like and prevents the support ring 320 from being separated from the support frame 319.

Also, the fixing frame 322 restricts a rotation range of the support ring 320 so as to restrict the support ring 320 and the knob ring 304 to rotating leftward and rightward only within the predetermined angle.

As shown in the drawing, the fixing frame 322 may have a bow-tie shape. Parts corresponding to wings of the fixing frame 322 restrict the support ring 320 to rotating within the predetermined angle. Also, a part connecting the both wings of the fixing frame 322 fixes the support ring 320 to prevent the support ring 320 from being separated.

Meanwhile, the knob ring 304 according to one embodiment of the present disclosure has a return type operational structure. In other words, in a state in which the knob ring 304 has moved in the first direction or the second direction due to a pressure applied by the user, when the pressure applied by the user is released, the knob ring 304 returns to an initial position.

Return springs S1 and S2 provide restoring forces to allow the knob ring 304 to return to the initial position. A first return spring S1 provides a restoring force clockwise, and a second return spring S2 provides a restoring force counterclockwise. When a pressure is not applied to the knob ring 304 from the outside, elastic forces of the first return spring S1 and the second return spring S2 balance such that the knob ring 304 remains in the initial position.

Both ends of the return springs S1 and S2 may be fixed to the support ring 320 and the support frame 319, respectively. Since the support ring 320 and the knob ring 304 rotate integrally, the knob ring 304 may rotate within the predetermined angle clockwise or counterclockwise while remaining in its initial position due to the elastic forces of the return springs S1 and S2.

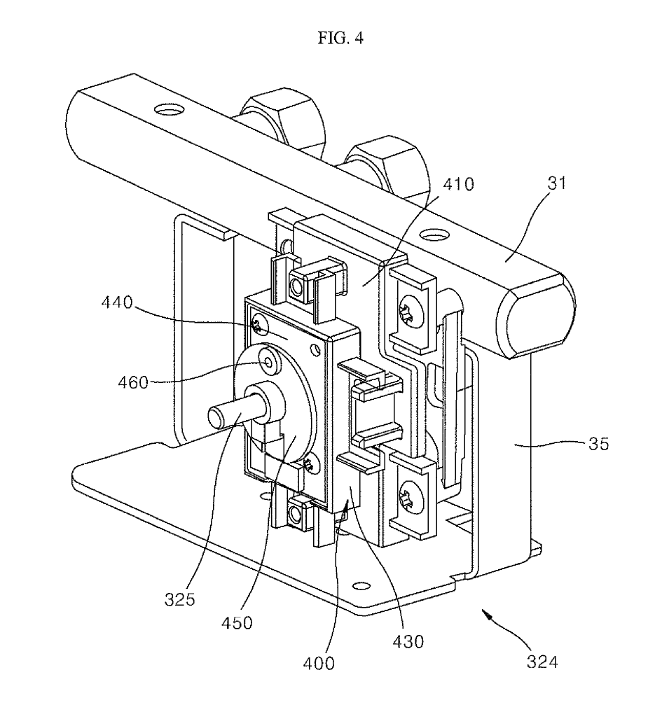

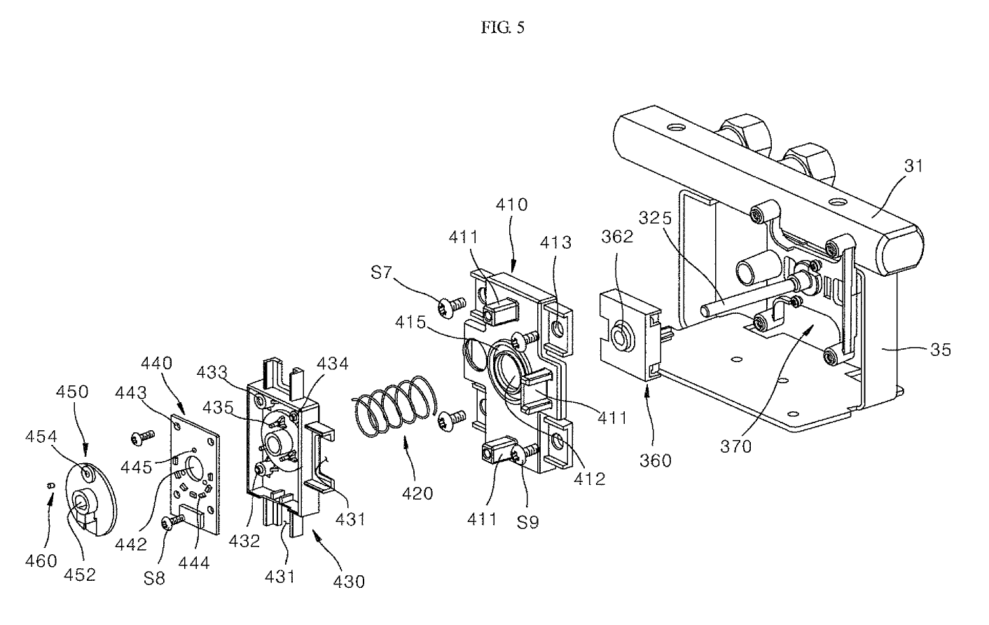

FIG. 4 is a perspective view of a heating power adjustment unit according to another embodiment of the present disclosure. FIG. 5 is an exploded view of the heating power adjustment unit according to another embodiment of the present disclosure.

As shown in the drawings, the heating power adjustment unit 324 includes a valve 370 combined with a gas pipe 31 and a gas pipe frame 35, an ignition switch 360 fitting on a valve shaft 325 of the valve 370, and a knob sensor 400.

The knob sensor 400 may detect a rotation angle of a valve shaft 330 by sensing a position of a knob sensor magnet 460 included in a rotating plate 450 through a plurality of hall sensors 444 arranged radially on a knob sensor substrate 440.

As shown in FIG. 5, the plurality of hall sensors 444 are arranged at equidistance radially on the knob sensor substrate 440. Hereinafter, a rightmost hall sensor is referred to as a first hall sensor, and other hall sensors will be sequentially referred to as second to seventh hall sensors.

The knob sensor 400 forms absolute coordinates by generating a different signal for each of the hall sensors 444 and detects a position of the knob sensor magnet 460 using the absolute coordinates.

That is, regardless of an immediately preceding position of the knob sensor magnet 460, when a finally received signal is a signal generated by an nth hall sensor, the knob sensor 400 determines a position of the knob sensor magnet 460 is a position corresponding to an nth hall sensor area.

Accordingly, even when a knob is rapidly operated, it is possible to precisely sense a final position of the knob sensor magnet 460 in a state in which rotation of a knob handle is grasped. Accordingly, a set value may be accurately detected.

The knob sensor 400 includes a knob sensor plate 410 fastened to the valve 370, a knob sensor housing 430 combined with the knob sensor plate 410 to be movable in an axial direction, a sensor spring 420 providing an elastic force between the knob sensor housing 430 and the knob sensor plate 410, the knob sensor substrate 440 which includes the hall sensors 444 and is fastened to the knob sensor housing 430, and the rotating plate 450 which is combined with the valve shaft, rotates integrally with the valve shaft, and is combined with the knob sensor magnet 460 sensed by the hall sensors 444.

The ignition switch 360 includes a valve shaft combination hole 362 having a D-shaped cross section. Accordingly, the ignition switch 360 receives a rotation force of the valve shaft such that an on/off state of the ignition switch 360 may be converted according to a rotation angle of the valve shaft. The ignition switch 360 changes to an on state when the valve shaft rotates by a certain angle and generates sparks at a fuel intake.

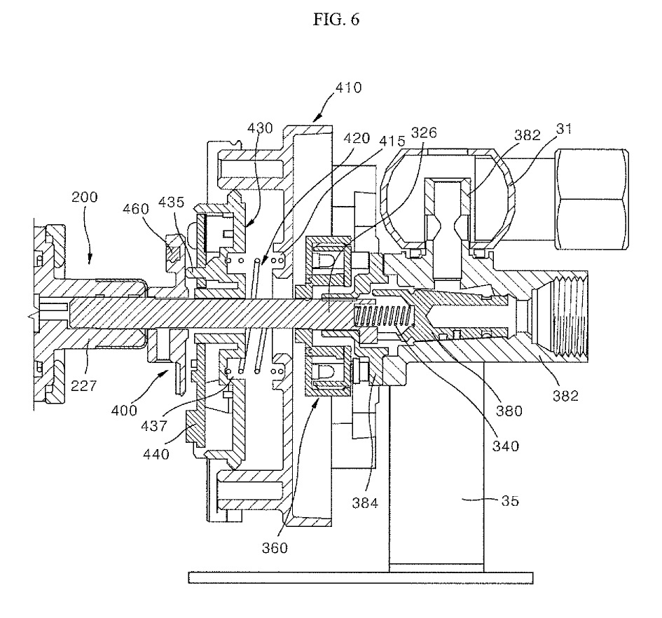

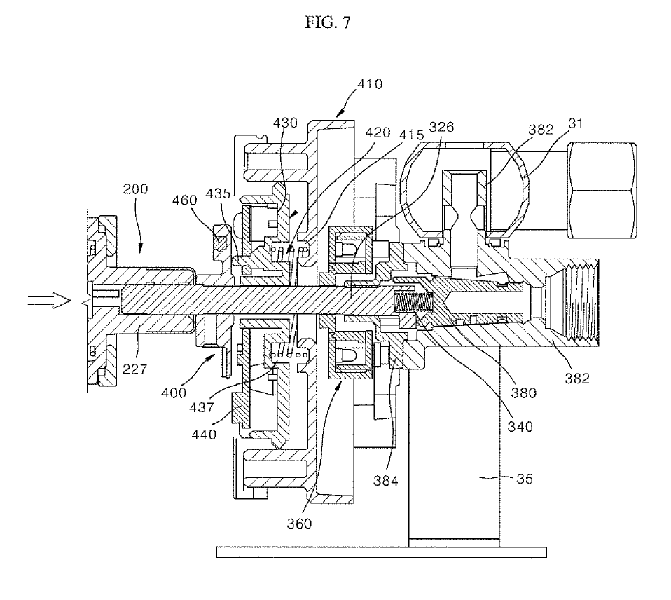

FIGS. 6 and 7 are cross-sectional views illustrating an operation of the heating power adjustment unit according to another embodiment of the present disclosure.

Referring to FIGS. 6 and 7, as a pressure is applied to the knob, a universal joint 200 moves in a direction of compressing the sensor spring 420. The sensor spring 420 and a valve spring 340 are compressed by movement of the universal joint 200, and the knob sensor housing 430, to which a rotating plate 50 and the knob sensor substrate 440 are fastened, and the valve shaft 325 move in a direction in which the sensor spring 420 is compressed.

When the pressure applied to the knob is removed, due to restoring forces of the valve spring 340 and the sensor spring 420, the knob sensor housing 430, to which the valve shaft 325 and the knob sensor substrate 440 are fastened, and the rotating plate 450 return to initial positions.

The knob sensor plate 410 is fastened to a valve cap 384, and the sensor spring 420 provides an elastic force in a direction in which the knob sensor housing 430 is pressed against the rotating plate 450. Accordingly, the rotating plate 450 comes into contact with a first shaft combination pipe 227 of the universal joint 200, and a supporting protrusion 435 of the knob sensor housing 430 comes into contact with the rotating plate 450.

A state in which the supporting protrusion 435 of the knob sensor housing 430 is in contact with the rotating plate 450 is always maintained when the knob is not pressed as shown in FIG. 6 or when the knob is pressed as shown in FIG. 7.

Accordingly, since the rotating plate 450 and the knob sensor plate 410 of the knob sensor may constantly maintain a uniform distance therebetween despite axial movement of the valve shaft, a distance between the knob sensor magnet 460 disposed on the rotating plate 450 and the hall sensors 444 arranged on the knob sensor plate 410 may be uniformly maintained. This structure increases operational reliability of the knob sensor 400.

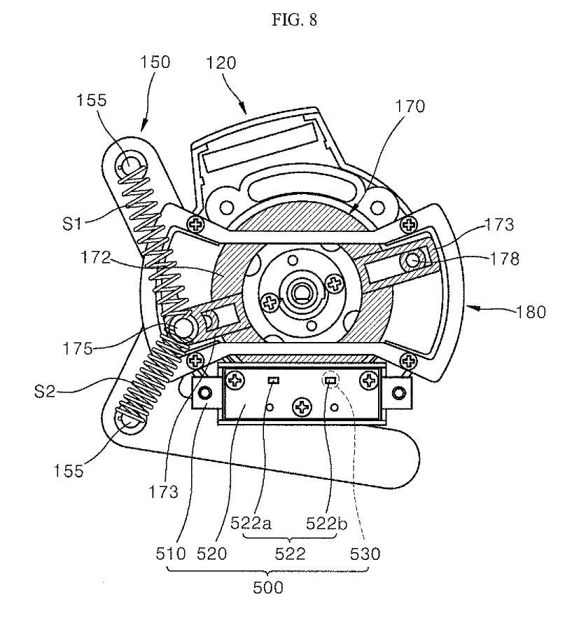

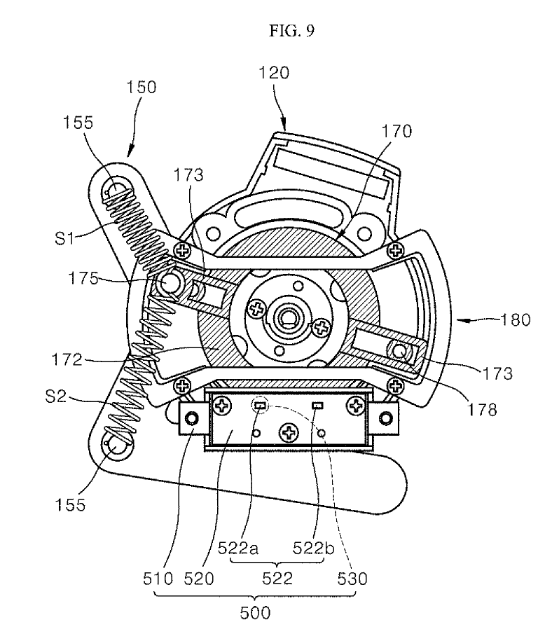

FIGS. 8 and 9 are cross-sectional views illustrating an operation of a knob ring according to another embodiment of the present disclosure.

Operating of a knob ring 120 may be recognized by rotation of an operational ring 170 rotated in cooperation with rotation of the knob ring 120. A knob ring sensor 500 is installed near the operational ring 170 and may sense the rotation of the knob ring 120 by sensing the rotation of the operational ring 170.

The operational ring 170 is combined with a pair of such return springs S1 and S2 which provide elastic forces for returning the operational ring 170 rotated to a position spaced apart from an initial position to the initial position.

Since the operational ring 170 and the knob ring 120 rotate integrally, the knob ring 120 remains in an initial position due to the elastic forces of the return springs S1 and S2 connected to the operational ring 170. Also, when a pressure is applied to the knob ring 120 which remains in the initial position as described above, the knob ring 120 may rotate within the predetermined angle clockwise or counterclockwise and may return to the initial position again due to the restoring forces provided by the return springs S1 and S2 when the pressure is related in a rotated state.

A position of a knob ring sensor magnet 530 is changed according to the rotation of the operational ring 170. The knob ring sensor 500 senses the rotation of the operational ring 170 by sensing a change in position of the knob ring sensor magnet 530 and senses the rotation of the knob ring 120 connected to the operational ring 170 therethrough.

The knob ring sensor magnet 530 is a component to be sensed by the knob ring sensor 500 and is installed on the operational ring 170. In the embodiment, it is exemplified that the knob ring sensor magnet 530 is installed on a circular plate part 172 of the operational ring 170. In the drawing, since the knob ring sensor magnet 530 is located on a rear surface of a knob ring sensor substrate 520, it is shown as a dotted line.

The knob ring sensor magnet 530 is installed on the circular plate part 172 to be disposed on one side surface of the circular plate part 172 facing the knob ring sensor 500. The knob ring sensor magnet 530 installed as described above is rotated with the operational ring 170 when the operational ring 170 rotates.

In the embodiment, it is exemplified that the knob ring sensor magnet 530 is disposed in a position adjacent to an outer circumferential surface of the circular plate part 172. The knob ring sensor magnet 530 disposed in the above-described position draws a track similar to a shape of an outer circumferential surface of the circular plate part 172 having a circular shape during the rotation of the operational ring 170 such that a position of the knob ring sensor magnet 530 may change.

The knob ring sensor 500 is provided to sense the change in position of the knob ring sensor magnet 530 and is fastened to a support frame 150 on a rear surface of the operational ring 170.

The knob ring sensor 500 includes a knob ring sensor housing 510, the knob ring sensor substrate 520, and hall sensors 522a and 522b.

The knob ring sensor housing 510 is fixedly installed on the support frame 150, that is, in more detail, on a bottom part of a frame body part 141. The knob ring sensor substrate 520 connected to the control unit of the cooking device is installed on the knob ring sensor housing 510.

In the embodiment, it is exemplified that the knob ring sensor substrate 520 is installed on the knob ring sensor housing 510 to be installed on a side facing the frame body part 141 and the knob ring sensor magnet 530. Also, a sensor for sensing the change in position of the knob ring sensor magnet 530 is installed on the knob ring sensor substrate 520.

The knob ring sensor 500 having the above components senses a position of the knob ring sensor magnet 530 in a non-contact manner like the knob sensor 400. To this end, the knob ring sensor magnet 530 may include a magnetic member which generates a magnetic force, and the knob ring sensor 500 may include a hall sensor 522 which senses the magnetic force of the magnetic member which approaches within a certain distance.

The hall sensor 522 is installed on the knob ring sensor substrate 520, senses the magnetic force of the knob ring sensor magnet 530 when the knob ring sensor magnet 530 approaches the hall sensor 522 within a certain distance, and generates a signal corresponding thereto.

The knob ring sensor 500 includes a plurality of such hall sensors 522, and the plurality of hall sensors 522 are arranged to be spaced at certain intervals apart along a rotational path of the knob ring sensor magnet 530.

That is, when the knob ring sensor magnet 530 rotates while drawing a circular track similar to the shape of the outer circumferential surface of the circular plate part 172 during the rotation of the operational ring 170, the plurality of hall sensors 522 are arranged on the knob ring sensor 500 to be located on an arc corresponding to a rotational track of the knob ring sensor magnet 530.

In the embodiment, arrangements of the hall sensors 522a and 522b and the knob ring sensor magnet 530 are exemplified that the pair of hall sensors 522a and 522b are arranged on the knob ring sensor 500, and the knob ring sensor magnet 530 is located between the pair of hall sensors 522 when the knob ring 120 and the operational ring 170 are in the initial positions.

Accordingly, when the knob ring 120 rotates in one direction, the knob ring sensor magnet 530 approaches any one of the pair of hall sensors 522 (hereinafter, referred to as a left hall sensor) within a certain distance such that the corresponding hall sensor 522a senses the knob ring sensor magnet 530. When the knob ring 120 rotates in the other direction, the knob ring sensor magnet 530 approaches the other of the pair of hall sensors 522 (hereinafter, referred to as a right hall sensor) within a certain distance such that the corresponding hall sensor 522b senses the knob ring sensor magnet 530.

To provide a cooking time setting function or timer function, when the knob ring 120 rotates in one direction, the knob ring sensor magnet 530 approaches the left hall sensor 522a within a certain distance such that the left hall sensor 522a senses the knob ring sensor magnet 530. Accordingly, operating of the knob ring 120 for initiating a cooking time setting mode is sensed by the knob ring sensor 500 such that the cooking time setting mode may be started.

Also, when the knob ring 120 is rotated in the other direction, the knob ring sensor magnet 530 approaches the right hall sensor 522b within a certain distance such that the right hall sensor 522b senses the knob ring sensor magnet 530. Accordingly, operating of the knob ring 120 for initiating the cooking time setting mode is sensed by the knob ring sensor 500 such that the cooking time setting mode may be started.

In the embodiment, it is exemplified that the hall sensors 522 generate different types of signals. That is, a signal generated by the left hail sensor 522a differs from a signal generated by the right hall sensor 522b.

Utilizing this, the knob ring 120 may be configured to have a function of setting a cooking time to be different according to a rotation direction of the knob ring 120 or a function of providing a different function according to the rotation direction of the knob ring 120.

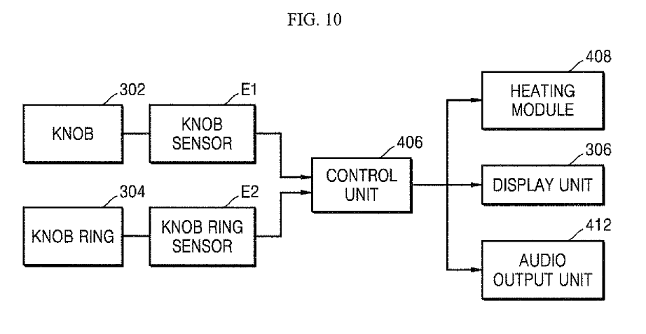

FIG. 10 is a block diagram illustrating components of the cooking device according to one embodiment of the present disclosure.

Referring to FIG. 10, the first knob module 231 includes the first knob 302, the knob sensor E1, the first knob ring 304, the knob ring sensor E2, and a first display unit 306.

For example, when the user pushes the first knob 302 and then applies a pressure in the first direction or the second direction, the first knob 302 rotates. A rotation direction and/or an amount of rotation of the first knob 302 is sensed by the knob sensor E1, and the knob sensor E1 transmits the sensed rotation direction and/or amount of rotation of the first knob 302 to a control unit 406.

The control unit 406 calculates a current position of the first knob 302 on the basis of the rotation direction and/or the amount of rotation of the first knob 302 transmitted from the knob sensor E1 and determines a heating power level set by the user rotating the first knob 302 on the basis of the calculated position.

Also, when the user applies a pressure in the first direction or the second direction while a part (for example, a finger) of a human body comes into contact with the first knob ring 304 or the first display unit 306, the first knob ring 304 rotates. A rotation direction and/or an amount of rotation caused by rotation of the first knob ring 304 is sensed by the knob ring sensor E2 or the knob ring sensor E4. The knob ring sensor E2 or the knob ring sensor E4 transmits the sensed rotation direction and/or amount of rotation of the first knob ring 304 to the control unit 406.

The control unit 406 determines the rotation direction of the first knob ring 304 and whether the first knob ring 304 rotates on the basis of the rotation direction and/or the amount of rotation of the first knob ring 304 transmitted from the knob ring sensor E2 or a knob ring sensor E4. The control unit 406 may determine that the first knob ring 304 has rotated only when the first knob ring 304 is rotated by a predetermined reference angle or more.

Also, the control unit 406 determines an operation state of the first knob ring 304 by comparing a time, in which the first knob ring 304 has rotated by the predetermined reference angle or more and a rotated state is maintained, with a predetermined reference time. When the first knob ring 304 remains in the rotated state for the reference time or more, the operation of the first knob ring 304 is determined as a holding operation. When the first knob ring 304 remains in the rotated state less than the reference time and returns to an initial position, the operation of the first knob ring 304 is determined as a click operation.

The control unit 406 increases or decreases the cooking time set by the user by a preset adjustment unit according to a rotation direction and an operation state of the first knob ring 304. For example, when the first knob ring 304 is clicked twice in the first direction, that is, counterclockwise, the control unit 406 decreases the cooking time set by the user by the preset adjustment unit, for example, one minute twice. As another example, while the first knob ring 304 remains in a state of being held in the second direction, that is, clockwise, the control unit 406 continuously increases the cooking time set by the user by the preset adjustment unit, for example, one minute in comparison to a time in which the first knob ring 304 is held.

Whenever the user sets or changes a heating power level or a cooking time using the first knob 302 or the first knob ring 304, the control unit 406 displays the heating power level or the cooking time set or changed by the user through the first display unit 306 provided on an outer circumferential surface of the first knob ring 304. In one embodiment of the present disclosure, when the user sets the heating power level or the cooking time, the control unit 406 may output a preset setting notification audio through a audio output unit 412.

The control unit 406 controls a heating module 408 to supply the heat energy at a level corresponding to a heating power level set by operating the first knob module 231. For example, the control unit 406 may adjust an opened or closed state and an opened and closed rate of a valve included in the heating module 408 such that an amount of gas supplied to a burner by the valve is set corresponding to a heating power level set by operating of the first knob module 231.

For reference, when the burner included in the heating module 408 operates in an electronic valve control manner, the opened or closed state and the opened or closed rate of the valve may be adjusted by a control signal of the control unit 406 in the electronic control manner. In another embodiment, when a burner included in the heating module 408 operates in a mechanical valve control manner, the first knob 302 and the valve may be mechanically connected to each other. Accordingly, the opened or closed state and the opened or closed rate of the valve may be mechanically changed according to a rotation direction and/or an amount of rotation of the first knob 302.

Also, the control unit 406 performs a cooking time measuring operation or a countdown operation on the basis of a cooking time set by operating the first knob module 231 or a timer.

The control unit 406 may measure a cooking time in which a heating operation of each heating area is performed from a time when a cooking time is set by the user and may compare the measured cooking time with the cooking time set by the user. As another example, when the user sets a cooking time, the control unit 406 may perform a countdown operation until the cooking time becomes 0. The countdown operation may be performed according to a preset countdown unit time, for example, one second. The control unit 406 displays a measured cooking time or a time being counted down on the first display unit 306.

Also, the control unit 406 may display information related to an operation state or an operation mode of an induction heating module 222 through the display unit 306 and may output a audio related to the operation state or the operation mode of the heating module 408 through the audio output unit 412. For example, when the cooking time set by the user is reached, the control unit 406 displays letters, for example, “---”, which notifies completion of the timer on the display unit 306 and outputs a audio which notifies of the completion of the timer through the audio output unit 412. According to the above-described notification operation, the user may intuitively recognize that the tinier is completed.

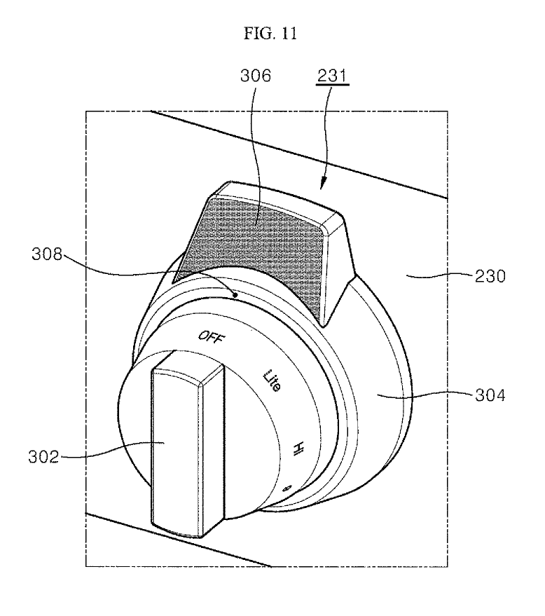

Hereinafter, a method of operating the knob module of the cooking device 1 according to one embodiment of the present disclosure will be described with reference to FIGS. 11 to 16.

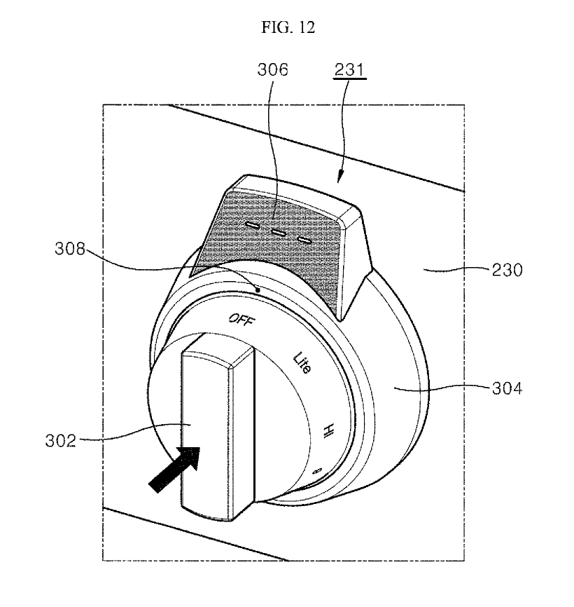

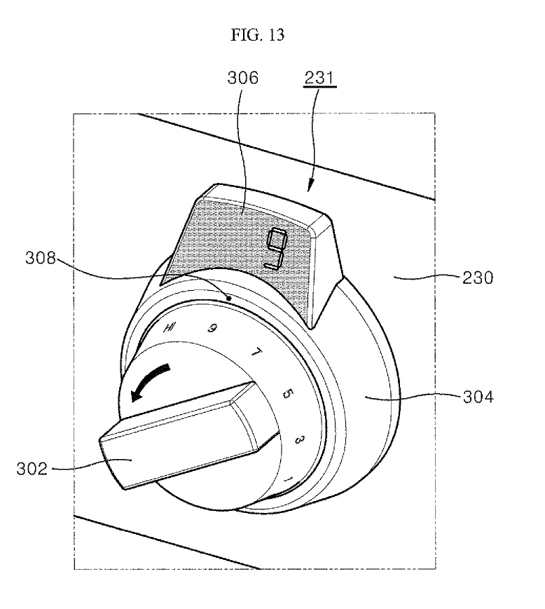

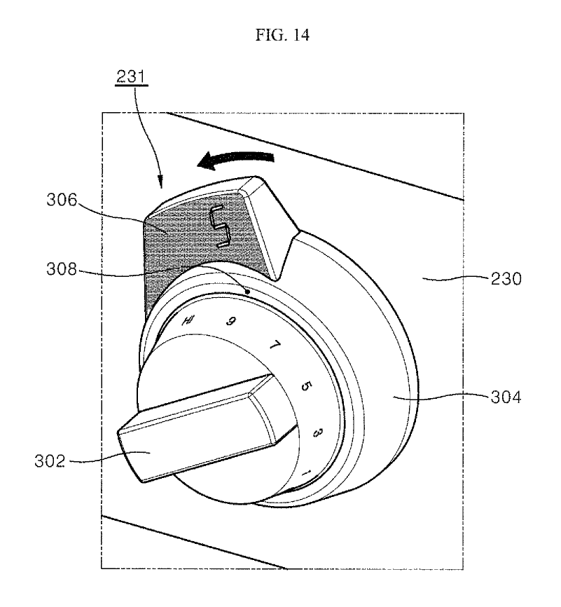

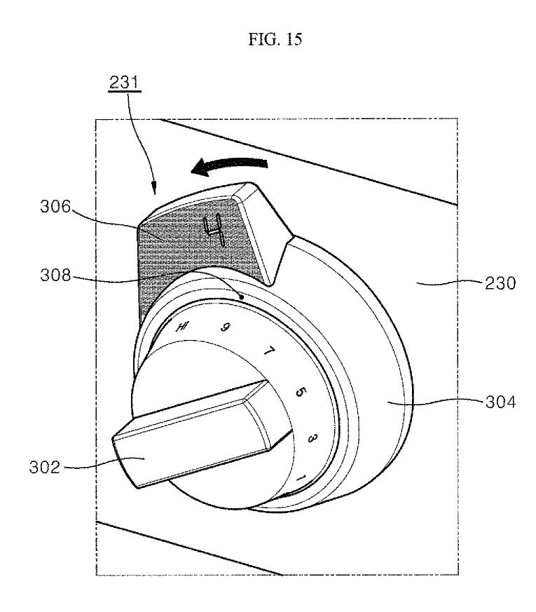

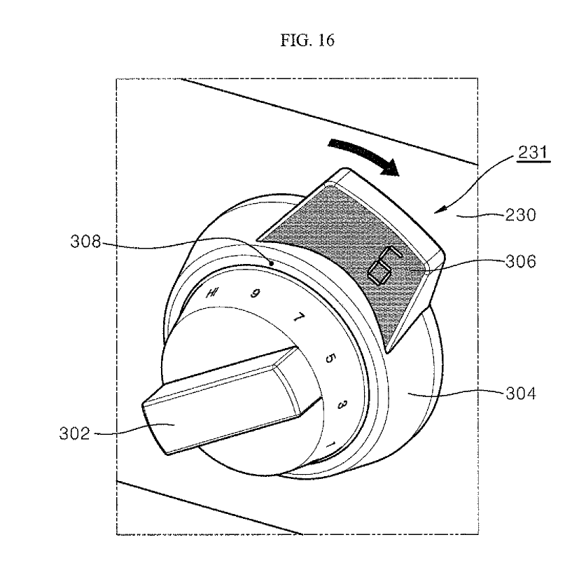

FIG. 11 illustrates an initialized state of the first knob module included in the cooking device according to one embodiment of the present disclosure. FIG. 12 illustrates a state in which the first knob of the first knob module is pressed according to one embodiment of the present disclosure. FIG. 13 illustrates a state in which the first knob of the first knob module has rotated according to one embodiment of the present disclosure. FIGS. 14 and 15 illustrate states in which the first knob ring of the first knob module has moved in the first direction according to one embodiment of the present disclosure. FIG. 16 illustrates a state in which the first knob ring of the first knob module has moved in the second direction according to one embodiment of the present disclosure.

For reference, although a method of operating the first knob module 231 for controlling the first burner 212 is shown in FIGS. 11 to 16, other knob modules may also be equally operated to the first knob module 231.

As shown in FIGS. 11 to 16, the first knob module 231 is combined with the control panel 230 and is disposed to protrude from the front surface of the control panel 230. The first knob module 231 includes the first knob 302, the first knob ring 304, and the first display unit 306.

In one embodiment of the present disclosure, the first knob 302 operates in a push-and-turn manner. That is, in order to set a heating power level or a cooking temperature using the first knob 302, it is necessary for the user to rotate the first knob 302 while a pressure is applied to the first knob 302 toward the control panel 230 (a push state). Depending on the embodiment, the heating power level or the cooking temperature may be set only by rotating the first knob 302 without a push.

The first knob 302 may infinitely be rotated in the first direction, for example, counterclockwise or the second direction, for example, clockwise. As shown in FIGS. 11 to 16, a plurality of heating power levels “Lite”, “Hi”, “9”, “7”, “5”, “3”, “1”, Simmer, OFF set to have a preset interval, for example, 1 corresponding to each rotation position of the first knob 302 are marked on a surface of the first knob 302.

The heating power levels marked on the first knob 302 indicate higher heating power levels as values thereof are higher, and “Hi” means the highest heating power level. Also, “Lite” means an operation of generating sparks using an ignition module and simultaneously supplying gas to generate flames at the burner. Also, “Simmer” means an operation of maintaining a heating power level of the burner lower than 1 in order to heat a container mounted on the burner at a very low temperature. Also, “OFF” means an end of the heating operation using the burner.

In the embodiment with reference to FIGS. 11 to 16, the heating power levels “Lite”, “Hi”, “9”, “7”, “5”, “3”, “1”, and “OFF” assigned to the first knob 302 are set to increase or decrease by 1 whenever the first knob 302 rotates. However, this is merely an example, and a value or an interval of each heating power level and a rotation angle of the first knob 302 corresponding to each heating power level may be variously set according to an embodiment.

The first knob ring 304 is a ring-shaped member surrounding the first knob 302 and rotates within the predetermined angle in the first direction, for example, counterclockwise or the second direction, for example, clockwise. That is, the user may move the first knob ring 304 within the predetermined angle in the first direction or the second direction by applying a pressure to the first knob ring through an outer surface of the first knob ring 304 or the first display unit 306. When the pressure applied to the first knob ring 304 by the user is removed, the first knob ring 304 returns to an initial position.

In the embodiment of the present disclosure, an operation, which is performed after the user moves the first knob ring 304 by the predetermined angle in an arbitrary direction, of returning the first knob ring 304 to an initial position before a preset reference time, for example, two seconds elapsed is defined as a click operation of the first knob ring 304. Also, an operation, which is performed after the user moves the first knob ring 304 in an arbitrary operation, of maintaining a state, in which the first knob ring 304 has moved, and a preset reference time, for example, two seconds is defined as a holding operation of the knob ring.

When the first knob ring 304 is moved by the predetermined angle in the first direction or the second direction while a cooking time or a timer is not set, a cooking time setting mode is started. When the cooking time setting mode is started, a number, for example, “5” which means a preset initial time, for example, five minutes is displayed on the first display unit 306.

When the first knob ring 304 is moved within the predetermined angle in the first direction or the second direction after the cooking time setting mode is started, a cooking time displayed on the first display unit 306 increases or decreases by a preset adjustment unit, for example, one minute. For example, when the user clicks the first knob ring 304 in the first direction, for example, counterclockwise, the cooking time set by the user decreases by one minute. Also, when the user clicks the first knob ring 304 in the second direction, for example, clockwise, a cooking time) set by the user increases by one minute.

As another example, when the user holds the first knob ring 304 in the first direction, for example, counterclockwise, until a held state of the first knob ring 304 is released, the cooking time set by the user continuously decreases by the preset adjustment unit, for example, one minute according to a preset speed. Also, when the user holds the first knob ring 304 in the second direction, for example, clockwise, until the held state of the first knob ring 304 is released, a cooking time set by the user continuously increases by the preset adjustment unit, for example, one minute according to a preset speed.

When the pressure applied to the first knob ring 304 by the user is released such that the first knob ring 304 returns to an initial position, a held state of the first knob ring 304 is released and an increase or decrease in the cooking time is also stopped. When the cooking time has changed and then is not changed any more for a certain time, for example, one second, the control unit may determine that setting of the cooking time is completed.

Accordingly, the user may easily and quickly set the heating power level, a cooking temperature, or the cooking time by operating the first knob ring 304.

The heating power level, the cooking temperature, or the cooking time set or adjusted by operating the first knob 302 or the first knob ring 304 by the user are displayed as letters or numbers on the first display unit 306. Also, a variety of types of letters, numbers, or symbols which refer to an operation state or an operation mode of the induction heating module 222 may be displayed on the first display unit 306.

A process of setting, by the user, a heating power level and a cooking time with respect to the second burner 214 of the induction heating module 222 using the first knob module 231 will be described as follows.

First, as shown in FIG. 11, when the cooking device 1 is in an off state or the induction heating module 222 does not start a heating operation even though the cooking device 1 is in an on state, the first knob module 231 remains in an initialized state. In the initialized state, nothing is displayed on the first display unit 306.

In the initialized state, when the user pushes the first knob 302 by applying a pressure toward the control panel 230, the first knob 302 is pushed by a certain distance toward the control panel 230 as shown in FIG. 12.

In a state in which the first knob 302 has been pushed, the user rotates the first knob 302 by referring to the heating power levels “Lite”, “Hi”, “9”, “7”, “5”, “3”, “1”, and “OFF” marked on the surface of the first knob 302. The user, in order to ignite flames at the burner, rotates the first knob 302 such that Lite thereof coincides with a reference point 308 and then rotates the first knob 302 such that a heating power level to be set among the heating power levels, “Hi”, “9”, “7”, “5”, “3”, and “1” marked on the surface of the first knob 302 coincides with a position of the reference point 308 as shown in FIG. 13.

Like the embodiment shown in FIG. 13, when the user rotates the first knob 302 such that a heating power level “9” is positioned at the reference point 308 and the pressure applied to the first knob 302 is released, the heating power level of the first burner 212 is set as “9”. Here, the heating power level “9” set by the user is displayed on the first display unit 306.

When a heating power level of the second burner 214 is set to be “9” using the first knob 302, the user may set a cooking time by operating the first knob ring 304.

When the first knob ring 304 is clicked in the first direction for example, counterclockwise or the second direction, for example, clockwise in a state in which a cooking time or a timer with respect to the first burner 212 is not set, a cooking time setting mode is started.

For example, like the embodiment shown in FIG. 14, when the user clicks the first knob ring 304 in the first direction while the cooking time or the timer is not set with respect to the second burner 214, a cooking time setting mode is started. When the cooking time setting mode is started, a number indicating a preset initial time, for example, five minutes is displayed on the first display unit 306 as shown in FIG. 14. Depending on the embodiment, with starting of the cooking time setting mode, a audio notifying the starting of the cooking time setting mode may be output.

In a state in which the cooking time setting mode is started, the user may adjust the cooking time displayed on the first display unit 306 as much as is desired by clicking or holding the first knob ring 304 in the first direction or the second direction.

For example, in a state in which “5”, which is an initial time, is displayed on the first display unit 306, when the user clicks once the first knob ring 304 in the first direction as shown in FIG. 15, the cooking time displayed on the first display unit 306 decreases by 1. Accordingly, “4” is displayed on the first display unit 306.

As another example, in a state in which “5”, which is an initial time, is displayed on the first display unit 306, when the user clicks once the first knob ring 304 in the second direction as shown in FIG. 16, the cooking time displayed on the first display unit 306 increases by 1. Accordingly, “6” is displayed on the first display unit 306.

Also, when the user holds the first knob ring 304 in the first direction or the second direction, in proportion to a time of holding the first knob ring 304, a number displayed on the first display unit 306 increases or decreases by the preset adjustment unit.

In one embodiment of the present disclosure, a displaying unit and an adjustment unit of an adjustment time displayed on the first display unit 306 may vary according to a level of a set adjustment time.

For example, when the adjustment time set by the user is less than 180 minutes, the displaying unit of the adjustment time displayed on the first display unit 306 is in minute. Accordingly, when the adjustment time set by the user is 8 minutes, “8” is displayed on the first display unit 306. When the adjustment time set by the user is 167 minutes, “167” is displayed on the first display unit 306.

Also, when the adjustment time set by the user is less than 180 minutes, an adjustment unit of a cooking time according to operating of the first knob ring 304 may be set as one minute. Accordingly, when the adjustment time set by the user is less than 180 minutes and the user clicks or holds the first knob ring 304, the cooking time displayed on the first display unit 306 increases or decreases by 1.

Also, when the adjustment time set by the user is 180 minutes or more, the displaying unit of the adjustment time displayed on the first display unit 306 is in hour. Accordingly, when the user sets the adjustment time as 180 minutes, “3H,” which means three hours, is displayed on the first display unit 306.

Also, when the adjustment time set by the user is 180 minutes or more, the adjustment unit of the cooking time according to operating of the first knob ring 304 may be set as one hour. Accordingly, when the adjustment time set by the user is “3H” and the user clicks or holds the first knob ring 304 to increase the adjustment time, the cooking time displayed on the first display unit 306 increases by 1 hour. However, when the adjustment time set by the user is “3H” and the user clicks or holds the first knob ring 304 to decrease the adjustment time, the cooking time displayed on the first display unit 306 is displayed in minute again and decreases by 1 minute.

Meanwhile, in order to cancel setting of the cooking time after the cooking time setting mode is started, while the cooking time is displayed on the first display unit 306, the user decreases the cooking time to a preset minimum value, for example, zero by operating the first knob ring 304.

For example, when the user clicks the first knob ring 304 five times in the first direction while “5” is displayed on the first display unit 306, a symbol, for example, “---”, which indicates cancellation of the cooking time setting mode is displayed on the first display unit 306 and the cooking time setting mode is canceled. Depending on the embodiment, with cancellation of the cooking time setting mode, a audio notifying of the cancellation of the cooking time setting mode may be output.

When a preset waiting time elapses after the cooking time setting mode is canceled, a current heating power level set with respect to the second burner 214 is displayed on the first display unit 306.

As described above, the user may quickly and easily set the heating power level and/or the cooking time with respect to the second burner 214 by operating the first knob 302 and the first knob ring 304 included in the first knob module 231.

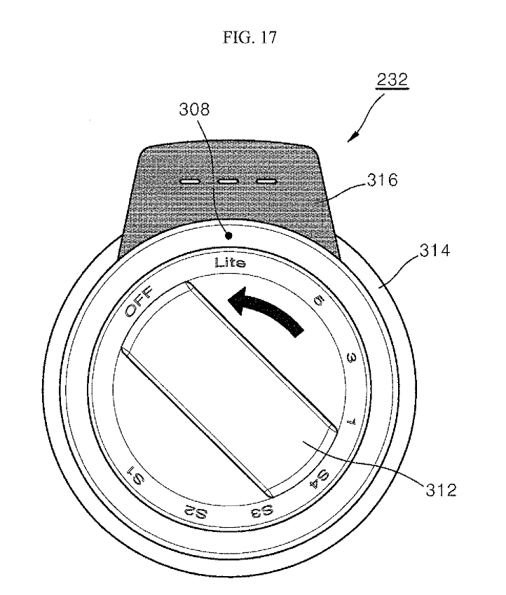

Hereinafter, a process of controlling a heating operation of the second burner 214 using the second knob module 232 will be described with reference to FIGS. 17 to 19.

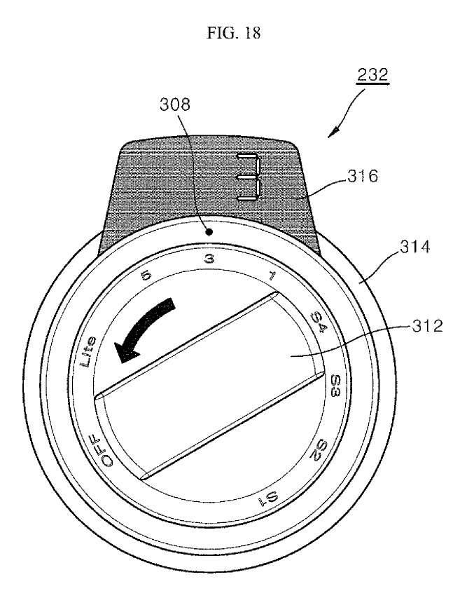

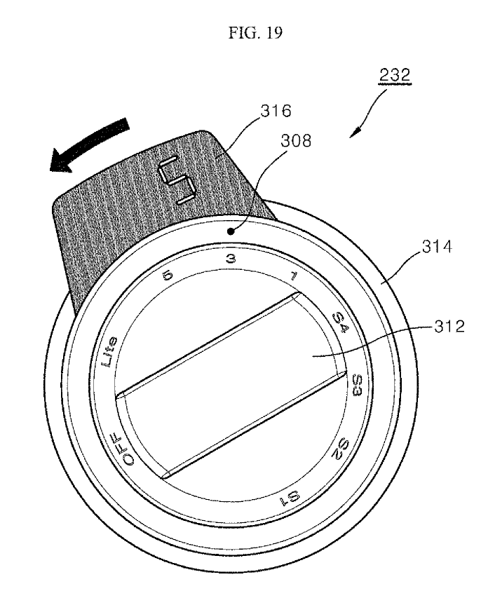

FIG. 17 illustrates a method of igniting flames at the second burner of the gas stove module using the second knob module according to one embodiment of the present disclosure. FIG. 18 illustrates a method of adjusting a heating power level of the second burner using the second knob module according to one embodiment of the present disclosure, FIG. 19 illustrates a method of setting a cooking time of the second burner using the second knob module according to one embodiment of the present disclosure.

As shown in FIGS. 17 to 19, a plurality of heating power levels “Lite”, “5”, “3”, “1”, “34”, “33”, “S2”, “S1”, and “OFF” corresponding to a rotational position of a second knob 312 are displayed on a surface of the second knob 312 of the second knob module 232. “Lite” is used for generating flames at the burner. Here, a lower number means a lower heating power. Also, “S4” to “S1” are used for maintaining a heating power lower than 1. Here, a lower number means a lower heating power. Particularly, when the heating power level is set to be “S3” to “S1,” flames of the second burner 214 are repeatedly generated and extinguished so as to provide very low heating power.

In order to use the second burner 214, the user mounts a container on the second burner 214 and then rotates the second knob 312 so as to locate “Lite” on a reference point 308 as shown in FIG. 17. Accordingly, flames are generated at the second burner 214.

Afterwards, the user adjusts the heating power level of the second burner 214 by rotating the second knob 312 in the first direction (counterclockwise) to allow a desired heating power level to coincide with the reference point 308. For example, when the second knob 312 rotates such that the reference point 308 coincides with a heating power level “3” as shown in FIG. 18, a valve of the second burner 214 is opened to a size corresponding to the heating power level 3 so as to supply gas to the second burner 214.

Also, the user may set a cooking time of the second burner 214 before or after setting the heating power level of the second burner 214. When the user clicks or holds a second knob ring 314 in the first direction or the second direction while the cooking time is not set, the cooking time setting mode is started.

For example, as shown in FIG. 19, when the user clicks the second knob ring 314 in the second direction while the cooking time or the timer is not set with respect to the second burner 214, the cooking time setting mode is started. When the cooking time setting mode is started, a number indicating a preset initial time, for example, five minutes is displayed on the first display unit 306 as shown in FIG. 19. Depending on the embodiment, with starting of the cooking time setting mode, a audio notifying of the starting of the cooking time setting mode may be output.

In a state in which the cooking time setting mode is started, the user may adjust the cooking time displayed on a second display unit 316 by clicking or holding the second knob ring 314 in the first direction or the second direction.

For example, in a state in which “5”, which is an initial time, is displayed on the second display unit 316, when the user clicks once the second knob ring 314 in the first direction, the cooking time displayed on the second display unit 316 decreases by 1. Accordingly, “4” is displayed on the second display unit 316.

As another example, in a state in which “5”; which is the initial time, is displayed on the second display unit 316, when the user clicks once the second knob ring 314 in the second direction, the cooking time displayed on the second display unit 316 increases by 1. Accordingly, “6” is displayed on the second display unit 316.

Also, when the user holds the second knob ring 314 in the first direction or the second direction for a certain time, in proportion to the time for which the first knob ring 304 maintains the holding state, a number displayed on the second display unit 316 increases or decreases by the preset adjustment unit.

When the cooking time has changed and then is not changed any more for a certain time, for example, one second, the control unit 406 may determine that setting of the cooking time is completed. When the setting of the cooking time is completed, the control unit 406 starts an operation of measuring or counting down the cooking time. During the operation of measuring or counting down the cooking time, when the user adjusts the cooking time again by operating the second knob ring 314, the cooking time is reset.

When the user sets the cooking time using the second knob ring 314, the countdown of the cooking time set by the user is started through the second display unit 316. When the cooking time set by the user is reached, it may be displayed on the second display unit 316 that the countdown is finished. Also, when the cooking time set by the user is reached, a audio notifying of completion of the countdown may be output through the audio output unit 412.

In another embodiment, when the cooking time set by the user is reached, the control unit 406 may finish the heating operation of the second burner 214 by controlling the gas valve to be blocked.

When the user does not set the cooking time, the control unit 406 may finish the heating operation of the second burner 214 according to a heating operation end command of the user or may finish the heating operation of the second burner 214 when a predetermined time limit is elapsed.

As stated above, the displaying unit and the adjustment unit of the cooking time displayed on the second display unit 316 may vary according to an amount of the set cooking time.

Meanwhile, in order to cancel setting of the cooking time after the cooking time setting mode is started, while the cooking time is displayed on the second display unit 316, the user decreases the cooking time to the preset minimum value, for example, zero by operating the second knob ring 314.

For example, when the user clicks the second knob ring 314 five times in the first direction while “5” is displayed on the second display unit 316, a symbol, for example, “---”, which indicates cancellation of the cooking time setting mode is displayed on the second display unit 316 and the cooking time setting mode is canceled. Depending on the embodiment, with cancellation of the cooking time setting mode, a audio notifying the cancellation of the cooking time setting mode may be output.

When a preset waiting time elapses after the cooking time setting mode is canceled, the current heating power level previously set is displayed again on the second display unit 316.

Although the embodiment of controlling the heating operation of the second burner 214 using the second knob module 232 has been described above, another burner may also be controlled in the same way using a corresponding knob module.

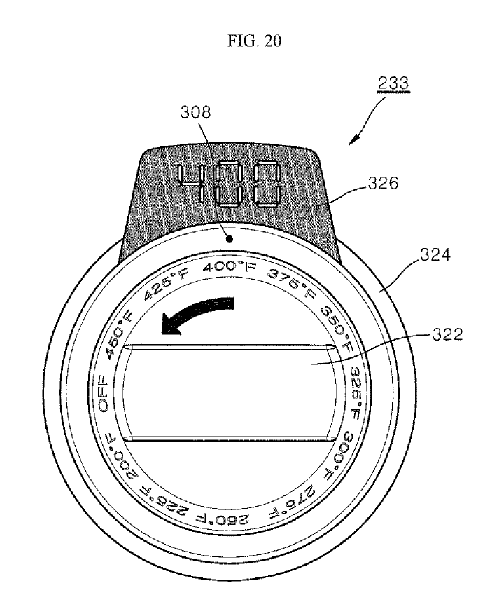

Hereinafter, a process of controlling a heating operation of the griddle module 202 using the third knob module 233 will be described with reference to FIGS. 20 to 22.

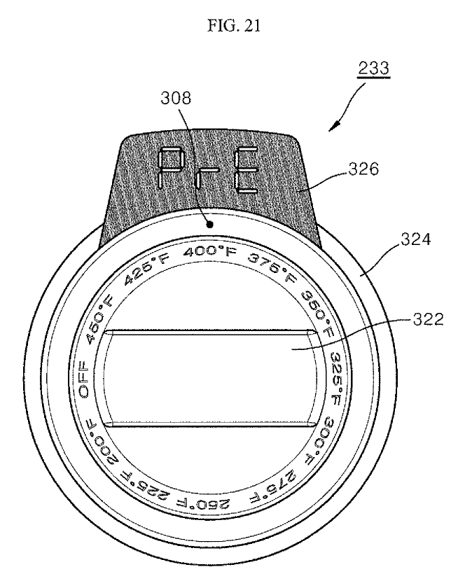

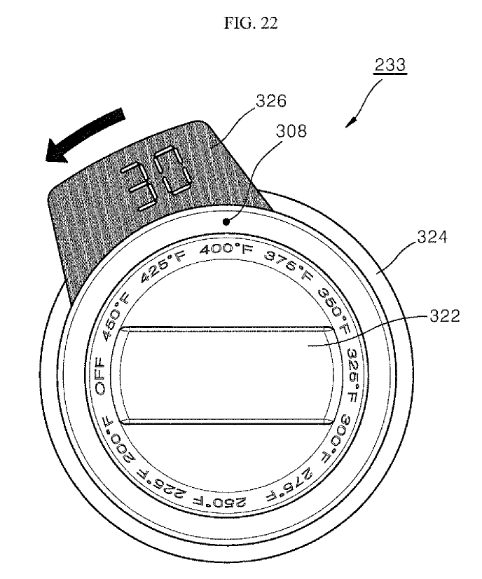

FIG. 20 illustrates a method of adjusting a heating power level of the griddle module using the third knob module according to one embodiment of the present disclosure. FIG. 21 is a view illustrating a preheating end notification operation of the griddle module according to one embodiment of the present disclosure. FIG. 22 illustrates a method of setting a cooking time of the griddle module using the third knob module according to one embodiment of the present disclosure.

As shown in FIGS. 20 to 22, a plurality of cooking temperature levels or heating power levels “450°”, “425°”, . . . , “200°”, and “OFF” corresponding to a rotational position of a third knob 322 are displayed on a surface of the third knob 322 of the third knob module 233.

In order to use the griddle module 202, the user rotates the third knob 322 of the third knob module 233 to match “400°” which is a desired cooking temperature with the reference point 308 as shown in FIG. 20. Accordingly, “400” which is the cooking temperature set by the user is displayed on a third display unit 326.

When the setting of the cooking temperature is completed, the control unit 406 generates flames at the heating device disposed below the griddle module 202, for example, a gas burner and supplies gas by controlling the valve. Accordingly, the heating operation of the griddle module 202 is started.

While the griddle 204 is heated by the gas burner, letters, for example, “PrE” which notifies that the griddle 204 is preheated to a temperature set by the user may be displayed on the third display unit 326.

When a temperature of the griddle 204 has reached the cooking temperature set by the user, the control unit 406 may perform a preheating end notification operation of notifying that the griddle 204 is completely preheated. For example, as shown in FIG. 21, the control unit 406 may control the letters “PrE” displayed on the third display unit 326 to blink. Also, the control unit 406 may output a audio notifying of completion of preheating through the audio output unit 412. Accordingly, the user may intuitively recognize that the griddle 204 is completely preheated.

Also, the user may set a cooking time or a timer in order to set a cooking temperature or when the griddle 204 is completely preheated.

As shown in FIG. 22, when the user rotates a third knob ring 324 in the first direction, a preset initial time, for example, 30 minutes is displayed on the third display unit 326 and the cooking time setting mode is started. The user may decrease the cooking time by clicking or holding the third knob ring 324 in the first direction or may increase the cooking time by clicking or holding the third knob ring 324 in the second direction.

When the cooking time is not changed for a preset waiting time after the user sets the cooking time, the control unit 406 determines that the cooking time is completely set and measuring or countdown of the cooking time is started. For example, the cooking time displayed on the third display unit 326 is decreased as much as a preset unit time, for example, one minute according to starting of the countdown.

When the countdown is completed, the control unit 406 performs a countdown end notification operation. For example, the control unit 406 may display a symbol “---” which notifies of completion of countdown through the third display unit 326. Also, the control unit 406 may output a audio notifying of completion of countdown through the audio output unit 412. Accordingly, the user may intuitively recognize that the cooking time set by the user is completed.

When the cooking time set by the user is reached, the control unit 406 may finish the heating operation by controlling the valve supplying gas to be blocked. In another embodiment, even when the cooking time set by the user is reached, the control unit 406 may maintain the heating operation until a heating operation end command is given by the user.

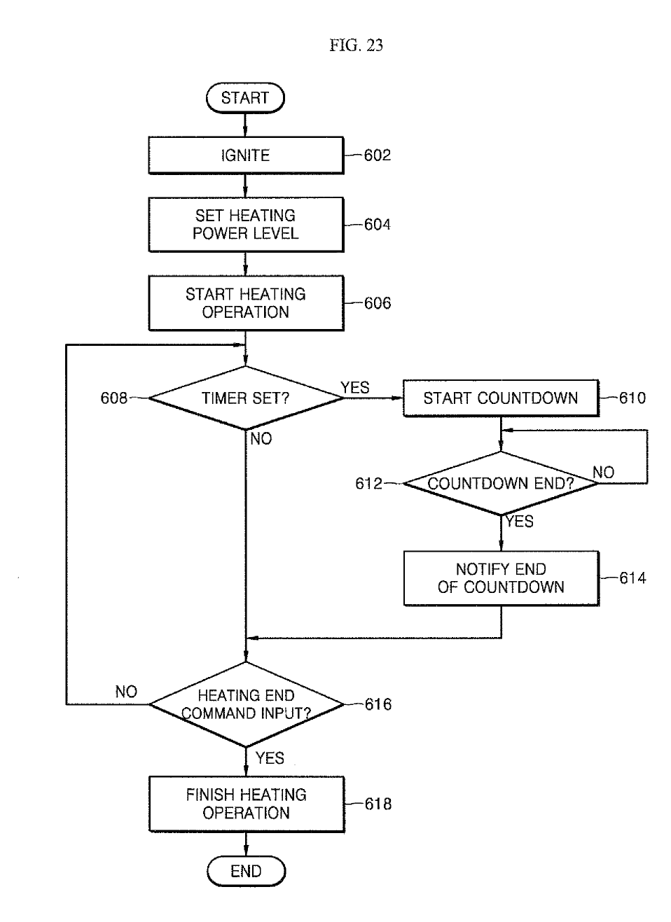

FIG. 23 is a flowchart illustrating a process of operations of the gas stove module according to one embodiment of the present disclosure.

First, a user rotates a knob of a knob module corresponding to a burner to be used such that a reference point of the knob coincides with “Lite.” Accordingly, flames are generated at the burner so as to perform ignition (602).

Next, the user sets a heating power level of the burner to be used, by rotating the knob of the knob module. The control unit 406 sets the heating power level of the burner on the basis of a heating power level of the knob module operated by the user (604).

When the heating power level is completely set, the control unit 406 supplies gas to the burner by adjusting an opened or closed rate of a valve to supply the heat energy corresponding to the set heating power level to a container. Accordingly, a heating operation of the burner is started (606).

While the heating operation of a heating area is performed, the control unit 406 checks whether a cooking time or a timer is set by the user (608).

When it is determined that the time is set by the user as a result of the checking in operation 608, the control unit 406 starts a countdown operation according to a preset unit time, for example, one second (610). The control unit 406 checks whether the countdown is finished (612) and continuously performs the countdown until the countdown is finished.

When it is determined that the countdown is finished as a result of the checking in operation 612, the control unit 406 notifies the completion of the countdown to the user (614).

Although not shown in the drawings, when the user operates the knob of the knob module to an OFF state and orders completion of the heating operation while performing operation 608 of checking the timer setting or operations 610 to 614 of performing the countdown, the heating operation of the heating area is immediately stopped.

After operation 608 of checking the timer setting or operation 610 to 614 of performing the countdown, the control unit 406 checks whether a heating end command is input by the user (616). As a result of the checking in operation 616, when the heating end command is not input, the control unit 406 maintains performing the heating operation. As a result of the checking in operation 616, when the heating end command is input, the control unit 406 finishes performing the heating operation.

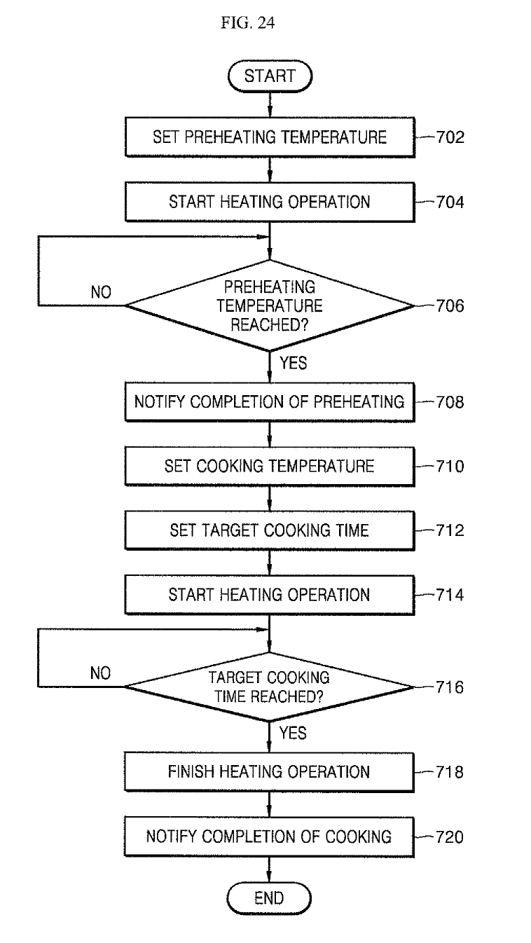

FIG. 24 is a flowchart illustrating a process of operations of the griddle module according to one embodiment of the present disclosure. For reference, in the embodiment shown in FIG. 24, the user preheats the griddle 204 using a preheating function of the griddle module 202 and cooks food on the griddle 204 after the griddle 204 is completely preheated.

The user sets a desirable cooking temperature by operating the first knob 302 of the first knob module 231. The control unit 406 sets the cooking temperature set by the user as a preheating temperature (702) and controls a heating device, for example, a gas burner to start a heating operation according to the set preheating temperature (704).

While the heating operation is performed by the gas burner, letters, for example, “Pre” which notify that a griddle module 202 performs the heating operation may be displayed on the first display unit 306 of the first knob module 231.

The control unit 406 checks whether the temperature of the griddle 204 measured by a temperature sensor installed below the griddle 204 reaches the previously set preheating temperature (706). As a result of the checking, when the current temperature of the griddle 204 does not reach the preheating temperature, the control unit 406 maintains the heating operation of the gas burner.

Meanwhile, although not shown in the drawing, while the heating operation for preheating is performed, the user may reset the preheating temperature by operating the first knob module 231. In this case, the control unit 406 compares the preheating temperature reset by the user with the current temperature of the griddle 204.

As a result of the comparing, when the preheating temperature reset by the user is lower than the current temperature of the griddle 204, the control unit 406 deems that the current temperature of the griddle 204 reaches the preheating temperature reset by the user, in other words, the preheating is completed and the control unit 406 performs a preheating end notification operation (708).

As a result of the comparing, when the preheating temperature reset by the user is higher than the current temperature of the griddle 204, the control unit 406 maintains the heating operation of the gas burner until the current temperature of the griddle 204 reaches the preheating temperature reset by the user.

Meanwhile, as a result of the checking in operation 706, when the current temperature of the griddle 204 reaches the preheating temperature, the control unit 406 performs the preheating end notification operation (708). For example, the control unit 406 may allow the letters, for example, “Pre” displayed on the first display unit 306 or the previously set preheating temperature to blink. As another example of the preheating end notification operation, the control unit 406 may output a audio notifying of completion of preheating through the audio output unit 412.

The control unit 406 may maintain performing of the preheating end notification operation only for a preset notification time or may continuously perform the preheating end notification operation until the user operates the knob module.

The user that recognizes that preheating is completed sets a cooking temperature using the first knob 302 of the first knob module 231 (710) and sets a target cooking time using the first knob ring 304 (712).

Depending on the embodiment, the setting, by the user, of the cooking temperature (710) may be omitted and only the target cooking time may be set. In another embodiment, only the setting of the cooking temperature (710) may be performed and the setting of the target cooking time (712) may not be performed. When the user does not set a target cooking time, the control unit 406 may set the target cooking time within a preset default time limit, for example, five minutes.

When setting of the cooking temperature and/or the target cooking time is completed, the control unit 406 controls such that the heating operation of the gas burner is started according to the set cooking temperature (714). Also, measurement or count down of the cooking time is started at a point in time when the heating operation is started.

Here, the first display unit 306 may sequentially display time such that a cooking progress time increases a preset unit time, for example, one minute or one hour from zero or may display the cooking progress time in a countdown manner in which a time decreases by a preset unit time, for example, one minute or one hour from the target cooking time set by the user.

The control unit 406 checks whether the cooking time reaches the target cooking time set by the user while the heating operation is performed (716).

As a result of the checking in operation 716, when the cooking time does not reach the target cooking time, the heating operation is maintained.

As a result of the checking in operation 716, when the cooking time reaches the target cooking time, the control unit 406 finishes the heating operation of the griddle module 202 (718).

When the heating operation is finished, the control unit 406 performs a cooking end notification operation for notifying that food is completely cooked by the heating operation of the griddle module 202 (720).

For example, the control unit 406 displays letters, for example, “End” for notifying that cooking is completed on the second display unit 316 or may allow the displayed letters or numbers to blink. As another example of the cooking end notification operation, the control unit 406 may output a audio notifying of completion of cooking through the audio output unit 412.

The cooking end notification operation may be performed only for a preset notification time or may be continuously performed until the user operates the knob module.

Depending on the embodiment, in operation 716, when the cooking time reaches the target cooking time, the heating operation is not finished and only the cooking end notification operation for notifying the user that the target cooking time is reached may be performed. For example, the letters for notifying that the target cooking time is reached or the cooking temperature set by the user may blink on the first display unit 306 or a notification audio may be output through the audio output unit 412. Afterwards, when the user inputs a heating end command by operating the first knob 302, the heating operation of the gas burner is finished.

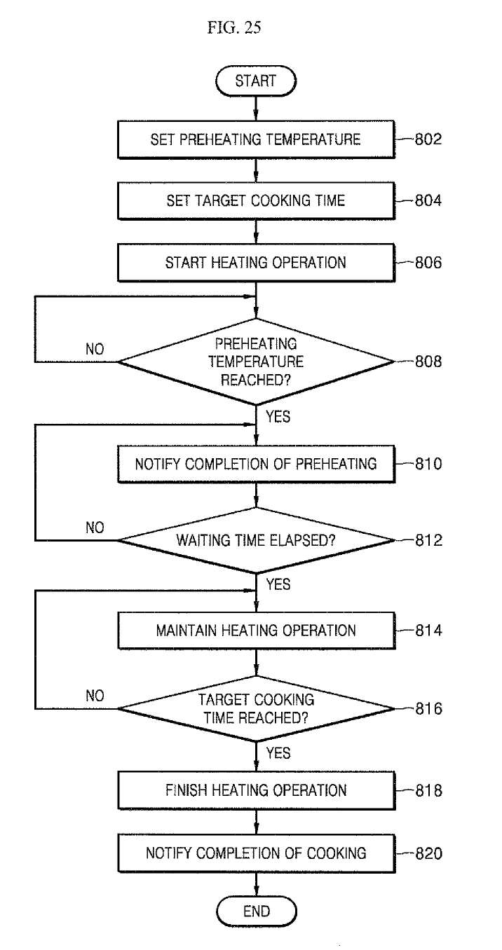

FIG. 25 is a flowchart illustrating a process of operations of the griddle module according to another embodiment of the present disclosure. For reference, in the embodiment shown in FIG. 25, the user does not use a preheating function and cooking is started while food is put on the griddle 204 from the beginning.

The user sets a desirable cooking temperature by operating the first knob 302 of the first knob module 231. Also, the user sets a desirable target cooking time by operating the second knob 312 or the second knob ring 314 of the second knob module 232.

The control unit 406 sets the cooking temperature set by the user as the preheating temperature (802) and sets the cooking time set by the user as the target cooking time (804). The control unit 406 controls such that the heating operation of the gas burner is started according to the set preheating temperature (806).

Here, the control unit 406 starts measurement or countdown of the cooking time from a point in time of starting the preheating operation. However, in another embodiment of the present disclosure, although the user sets the target cooking time, the measurement or the countdown of the cooking time is not started from the point in time of starting the preheating operation and may be started from a point in time when a waiting time elapses which will be described below (refer to operation 812).

While the preheating operation is performed by the gas burner, letters, for example, “Pre” which notify that the griddle module 202 performs the heating operation may be displayed on the first display unit 306 of the first knob module 231.

The control unit 406 checks whether the temperature of the griddle 204 measured by a temperature sensor installed below the griddle 204 reaches the previously set preheating temperature (808). As a result of the checking, when the current temperature of the griddle 204 does not reach the preheating temperature, the control unit 406 maintains the heating operation.

Meanwhile, although not shown in the drawing, while the heating operation for preheating is performed, the user may reset the preheating temperature by operating the first knob module 231. In this case, the control unit 406 compares the preheating temperature reset by the user with the current temperature of the griddle 204.

As a result of the comparing, when the preheating temperature reset by the user is lower than the current temperature of the griddle 204, the control unit 406 deems that the current temperature of the griddle 204 reaches the preheating temperature reset by the user, in other words, the preheating is completed and the control unit 406 performs a preheating end notification operation (810).

As a result of the comparing, when the preheating temperature reset by the user is higher than the current temperature of the griddle 204, the control unit 406 maintains the heating operation of the gas burner until the current temperature of the griddle 204 reaches the preheating temperature reset by the user.

Meanwhile, as a result of the checking in operation 808, when the current temperature of the griddle 204 reaches the preheating temperature, the control unit 406 performs the preheating end notification operation (810). For example, the control unit 406 may allow the letters, for example, “Pre” displayed on the first display unit 306 or the previously set preheating temperature to blink. As another example of the preheating end notification operation, the control unit 406 may output a audio notifying of completion of preheating through the audio output unit 412.

The control unit 406 may maintain performing of the preheating end notification operation only for a preset notification time or may continuously perform the preheating end notification operation until the user operates the knob module.

When the preheating is completed, the control unit 406 waits for operating, by the user, of the first knob module 231 for a preset waiting time. When the user changes the cooking temperature or the cooking time by operating the first knob module 231 or the second knob module 232 before the waiting time elapses, the control unit 406 performs operation 710 and operation 720 shown in FIG. 24.

However, when the user does not operate the first knob module 231 when the waiting time is reached, the control unit 406 sets a previously set preheating temperature as the cooking temperature and sets a previously set target cooking time as the target cooking time. The control unit 406 maintains the heating operation on the basis of the set cooking temperature and the target cooking time (814).

As described above, the measurement or the countdown of the cooking time may be started from the point in time of starting the preheating operation (806) or the point in time when the waiting time is reached (812).

Here, the first display unit 306 may sequentially display such that a cooking progress time increases a preset unit time, for example, one minute or one hour or may display the cooking progress time in a countdown manner in which a time decreases by a preset unit time, for example, one minute or one hour from the target cooking time set by the user.

The control unit 406 checks whether the cooking time reaches the target cooking time set by the user while the heating operation is performed (816).

When the cooking time does not reach the target cooking time as a result of the checking in operation 816, the heating operation is maintained.

When the cooking time reaches the target cooking time as a result of the checking in operation 816, the control unit 406 finishes the heating operation (818).

Also, when the heating operation is finished, the control unit 406 performs a cooking end notification operation for notifying that food is completely cooked by the heating operation of the griddle module 202 (820).

For example, the control unit 406 displays letters, for example, “End” for notifying that cooking is completed on the first display unit 306 or may allow the displayed letters or numbers to blink. As another example of the cooking end notification operation, the control unit 406 may output a audio notifying of completion of cooking through the audio output unit 412.

The cooking end notification operation may be performed only for a preset notification time or may be continuously performed until the user operates the knob module.

The cooking end notification operation may be performed only for the preset notification time or may be continuously performed until the user operates the knob module or opens a cover 210.

Depending on the embodiment, when the cooking time reaches the target cooking time in operation 816, the heating operation is not finished and only the cooking end notification operation for notifying the user that the target cooking time is reached may be performed. For example, the letters for notifying that the target cooking time is reached or the cooking temperature set by the user may blink on the first display unit 306 or a notification audio may be output through the audio output unit 412. Afterwards, when the user inputs a heating end command by operating the first knob 302, the heating operation of the gas burner is finished.

As described above, a cooking device according to embodiments of the present disclosure includes a knob operated in a push-and-turn manner and a knob ring operated in a click-or-holding manner. A user may easily and quickly set a cooking time or a level of heat energy supplied by a heating module included in the cooking device using the knob or the knob ring.

Also, since the user may operate the knob or the knob ring while checking information displayed on a display unit in real time, the cooking time or the level of the heat energy supplied by the heating module may be more easily and precisely set.

Also, even in a process in which cooking is performed by the cooking device, a variety of types of information related to cooking may be quickly and conveniently checked through the display unit.

According to the embodiments of the present disclosure, a cooking device has an advantage of easily and quickly adjusting a time for cooking food or adjusting a level of heat energy supplied by the cooking device.

Also, the cooking device has an advantage of allowing a user to easily and precisely recognize a level of heat energy supplied by the cooking device or a remaining cooking time during a cooking process.

Also, the cooking device has an advantage of allowing a user to more conveniently and precisely control a cooking process and to immediately check information necessary for cooking.

Although the embodiments of the present disclosure have been described above with reference to the exemplary drawings, the present disclosure is not limited to the embodiments and the drawings disclosed in the specification and it is apparent that a variety of modifications may be made by one of ordinary skill in the art without departing from the scope of the technical concept of the present disclosure. In addition, although operational effects of the components of the present disclosure have not been described through an explicit description, expectable effects of the corresponding components should also be acknowledged.

What is claimed is:

1. A cooking device comprising:
a heating module including a heating device for heating a container;
a control unit which controls a heating operation of the heating device; and
a knob module configured to set a heating power level of the heating module, a cooking temperature, or a cooking time,
wherein the knob module includes:
a knob to which the heating power level or the cooking temperature are assigned, the knob rotating in a first direction or a second direction, corresponding to each rotational position, and being setting to have preset intervals;
a knob ring which moves in the first direction or the second direction and then returns to an initial position thereof to increase or decrease the cooking time as much as a preset adjustment unit; and
a display unit formed at one side of the knob ring to display the heating power level, the cooking temperature or the cooking time.

2. The cooking device of claim 1, wherein when the knob ring is operated while the cooking time is not set, a cooking time setting mode is started.

3. The cooking device of claim 1, wherein when a user performs a click operation using the knob ring, the cooking time increases or decreases according to the number of instances of the click operation.

4. The cooking device of claim 1, wherein when a user performs a holding operation using the knob ring, the cooking time continuously increases or decreases until the holding operation is released.

5. The cooking device of claim 1, wherein when the cooking time is set, a countdown operation of the cooking time is performed, and when the countdown operation is completed, a countdown operation end notification operation is performed.

6. The cooking device of claim 1, wherein a displaying unit and an adjustment unit of the cooking time displayed on the display unit vary according to a length of the set cooking time.

7. The cooking device of claim 1, wherein when a user sets a preheating temperature using the knob module while a heating operation of the heating module is not started, the heating operation the heating module is performed until a temperature of the heating module reaches the preheating temperature.

8. The cooking device of claim 7, wherein when the temperature of the heating module reaches the preheating temperature, a preheating end notification operation using at least one of the display unit and a audio output unit is performed.

9. The cooking device of claim 7, wherein when the user sets the cooking temperature using the knob ring after the temperature of the heating module reaches the preheating temperature, the heating operation of the heating module is performed until a cooking time of the heating module reaches a preset target cooking time.

10. The cooking device of claim 9, wherein when the cooking time of the heating module reaches the target cooking time, a cooking end notification operation using at least one of the display unit and a audio output unit is performed audio output unit.

11. The cooking device of claim 7, wherein when the user does not set the cooking temperature until a preset waiting time passes after the temperature of the heating module reaches the preheating temperature, the heating operation of the heating module is performed on the basis of the preheating time until a cooking time of the heating module reaches a preset target cooking time.

12. The cooking device of claim 7, wherein when the user sets the preheating module to be lower than a current temperature of the heating module before the temperature of the heating module reaches the preheating temperature, the temperature of the heating module is regarded to have reached the preheating temperature.
